(19) United States
(12) Patent Application Publication
(10) Pub. No.: US 2025/0310812 A1
(43) Pub. Date: Oct. 2, 2025

(54) LAYER-3 BEAM AND CELL MEASUREMENT PREDICTIONS

(71) Applicant: QUALCOMM Incorporated, San Diego, CA (US)

(72) Inventors: Rajeev KUMAR, San Diego, CA (US); Aziz GHOLMIEH, Del Mar, CA (US); Punyaslok PURKAYASTHA, San Diego, CA (US); Hamed PEZESHKI, San Diego, CA (US)

(21) Appl. No.: 19/092,744

(22) Filed: Mar. 27, 2025

Related U.S. Application Data
(60) Provisional application No. 63/572,786, filed on Apr. 1, 2024.

(51) Int. Cl. H04W 24/10

(52) U.S. Cl. CPC H04W 24/10

(57) ABSTRACT

Methods, systems, and devices for wireless communications are described. A user equipment (UE) may generate layer 3 beam measurements based on layer 1 beam measurements and layer 1 beam predictions. For example, a UE may receive reference signals via a set of beams from a network entity, and the UE may perform a set of layer 1 measurements on the set of beams. The UE may generate, using an artificial intelligence (AI) or machine learning (ML) model, a set of layer 1 beam predictions based on the layer 1 measurements. The UE may generate a set of layer 3 beam measurements or predictions based on the set of layer 1 measurements and the set of layer 1 beam predictions in accordance with an adjustment procedure for the set of layer 1 beam predictions. The UE may transmit a report that indicates the layer 3 beam measurements.

### CROSS REFERENCES

The present application for patent claims benefit of U.S. Provisional Patent Application No. 63/572,786 by KUMAR et al., entitled “LAYER-3 BEAM AND CELL MEASUREMENT PREDICTIONS,” filed Apr. 1, 2024, assigned to the assignee hereof, and expressly incorporated herein.

### INTRODUCTION

The following relates to wireless communications, and more specifically to beam and cell measurements and predictions.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support layer-3 beam and cell measurement predictions.

A method for wireless communications by a user equipment (UE) is described. The method may include receiving a set of reference signals and transmitting a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

An apparatus for wireless communications at a UE is described. The apparatus may include one or more memories and one or more processors coupled with the one or more memories. The one or more processors may be configured to cause the UE to receive a set of reference signals and transmit a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

Another UE for wireless communications is described. The UE may include means for receiving a set of reference signals and means for transmitting a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

A non-transitory computer-readable medium storing code for wireless communications at a UE is described. The code may include instructions executable by one or more processors to cause the UE to receive a set of reference signals and transmit a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

Some examples of the method, apparatuses, UEs, and non-transitory computer-readable medium described herein may further include operations, features, means, or instructions for receiving, from a network entity, control information that indicates one or more adjustment parameters associated with layer 1 beam predictions, the adjustment procedure based on the one or more adjustment parameters.

In some examples of the method, apparatuses, UEs, and non-transitory computer-readable medium described herein, the one or more adjustment parameters include a first filtering coefficient value and an offset value.

Some examples of the method, apparatuses, UEs, and non-transitory computer-readable medium described herein may further include operations, features, means, or instructions for generating the set of layer 3 beam measurements based on multiplication of the set of layer 1 beam predictions by the first filtering coefficient value and addition of the offset value.

Some examples of the method, apparatuses, UEs, and non-transitory computer-readable medium described herein may further include operations, features, means, or instructions for receiving, via the control information, an indication of a second filtering coefficient value associated with layer 1 beam measurements, the second filtering coefficient value different from the first filtering coefficient value, where the set of layer 3 beam measurements may be generated based on multiplication of the set of layer 1 beam measurements by the second filtering coefficient value.

In some examples of the method, apparatuses, UEs, and non-transitory computer-readable medium described herein, the one or more adjustment parameters include a set of filtering coefficient values associated with the layer 1 beam predictions and layer 1 beam measurements for layer 3 beam measurements and the set of layer 3 beam measurements may be generated based on a filtering coefficient value of the set of filtering coefficient values selected based on a quantity of layer 1 beam predictions of the set of layer 1 beam predictions.

In some examples of the method, apparatuses, UEs, and non-transitory computer-readable medium described herein, the control information indicates the one or more adjustment parameters for each carrier frequency of a set of carrier frequencies, for each radio access technology of a set of radio access technologies, or for each cell of a set of cells.

Some examples of the method, apparatuses, UEs, and non-transitory computer-readable medium described herein may further include operations, features, means, or instructions for transmitting, to the network entity, assistance information that indicates a recommended filtering coefficient value based on a set of prior layer 3 beam measurements generated by the UE, where reception of the control information may be based on the assistance information.

In some examples of the method, apparatuses, UEs, and non-transitory computer-readable medium described herein, the transmitting the report message may include operations, features, means, or instructions for transmitting an indication of a confidence interval associated with the set of layer 3 beam measurements.

Some examples of the method, apparatuses, UEs, and non-transitory computer-readable medium described herein may further include operations, features, means, or instructions for modifying one or more layer 1 beam predictions of the set of layer 1 beam predictions based on subsequent layer 1 beam measurements corresponding to the one or more layer 1 beam predictions, where the subsequent layer 1 beam measurements may be a subset of the set of layer 1 beam measurements, and where the adjustment procedure includes the modifying the one or more layer 1 beam predictions.

Some examples of the method, apparatuses, UEs, and non-transitory computer-readable medium described herein may further include operations, features, means, or instructions for receiving, from a network entity, control information including an indication to modify the set of layer 1 beam predictions based on the subsequent layer 1 beam measurements, where the modifying the one or more layer 1 beam predictions of the set of layer 1 beam predictions may be based on the control information.

In some examples of the method, apparatuses, UEs, and non-transitory computer-readable medium described herein, the control information further indicates a quantity of layer 1 beam predictions to modify.

Some examples of the method, apparatuses, UEs, and non-transitory computer-readable medium described herein may further include operations, features, means, or instructions for selecting, based on a distribution of the set of layer 1 beam measurements and the set of layer 1 beam predictions, a filtering coefficient value for application to layer 1 beam predictions and layer 1 beam measurements for generation of layer 3 beam measurements, a quantity of layer 3 beam measurements to include in the set of layer 3 beam measurements, or both.

Some examples of the method, apparatuses, UEs, and non-transitory computer-readable medium described herein may further include operations, features, means, or instructions for receiving, from a network entity, control information that indicates a range of candidate filtering coefficient values, a range of candidate quantities of layer 3 beam measurements, or both, where the selecting may be based on the control information.

In some examples of the method, apparatuses, UEs, and non-transitory computer-readable medium described herein, the receiving the set of reference signals may include operations, features, means, or instructions for receiving a first set of synchronization signal blocks or a first set of channel state information reference signals, where the set of layer 3 beam measurements correspond to measurements of a second set of synchronization signal blocks or a second set of channel state information reference signals.

A method for wireless communications by a network entity is described. The method may include outputting a set of reference signals and obtaining a report message that indicates a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

An apparatus for wireless communications is described at a network entity. The apparatus may include one or more memories and one or more processors coupled with the one or more memories. The one or more processors may be configured to cause the network entity to output a set of reference signals and obtain a report message that indicates a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

Another network entity for wireless communications is described. The network entity may include means for outputting a set of reference signals and means for obtaining a report message that indicates a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

A non-transitory computer-readable medium storing code for wireless communications at a network entity is described. The code may include instructions executable by one or more processors to cause the network entity to output a set of reference signals and obtain a report message that indicates a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

Some examples of the method, apparatuses, network entities, and non-transitory computer-readable medium described herein may further include operations, features, means, or instructions for outputting, to the UE, control information that indicates one or more adjustment parameters associated with layer 1 beam predictions, the adjustment procedure based on the one or more adjustment parameters.

In some examples of the method, apparatuses, network entities, and non-transitory computer-readable medium described herein, the one or more adjustment parameters include a first filtering coefficient value and an offset value.

In some examples of the method, apparatuses, network entities, and non-transitory computer-readable medium described herein, the set of layer 3 beam measurements may be generated based on multiplication of the set of layer 1 beam predictions by the first filtering coefficient value and addition of the offset value.

Some examples of the method, apparatuses, network entities, and non-transitory computer-readable medium described herein may further include operations, features, means, or instructions for outputting, via the control information, an indication of a second filtering coefficient value associated with layer 1 beam measurements, the second filtering coefficient value different from the first filtering coefficient value, where the set of layer 3 beam measurements may be generated based on multiplication of the set of layer 1 beam measurements by the second filtering coefficient value.

In some examples of the method, apparatuses, network entities, and non-transitory computer-readable medium described herein, the one or more adjustment parameters include a set of filtering coefficient values associated with the layer 1 beam predictions and layer 1 beam measurements for layer 3 beam measurements and the set of layer 3 beam measurements may be generated based on a filtering coefficient value of the set of filtering coefficient values selected based on a quantity of layer 1 beam predictions of the set of layer 1 beam predictions.

In some examples of the method, apparatuses, network entities, and non-transitory computer-readable medium described herein, the control information indicates the one or more adjustment parameters for each carrier frequency of a set of carrier frequencies, for each radio access technology of a set of radio access technologies, or for each cell of a set of cells.

Some examples of the method, apparatuses, network entities, and non-transitory computer-readable medium described herein may further include operations, features, means, or instructions for obtaining assistance information that indicates a recommended filtering coefficient value from the UE based on a set of prior layer 3 beam measurements associated with the UE, where transmission of the control information may be based on the assistance information.

In some examples of the method, apparatuses, network entities, and non-transitory computer-readable medium described herein, the obtaining the report message may include operations, features, means, or instructions for obtaining an indication of a confidence interval associated with the set of layer 3 beam measurements.

Some examples of the method, apparatuses, network entities, and non-transitory computer-readable medium described herein may further include operations, features, means, or instructions for outputting control information including an indication to modify the set of layer 1 beam predictions based on subsequent layer 1 beam measurements, where the adjustment procedure may be based on the control information.

In some examples of the method, apparatuses, network entities, and non-transitory computer-readable medium described herein, the control information further indicates a quantity of layer 1 beam predictions to modify.

Some examples of the method, apparatuses, network entities, and non-transitory computer-readable medium described herein may further include operations, features, means, or instructions for outputting control information that indicates a range of candidate filtering coefficient values, a range of candidate quantities of layer 3 beam measurements, or both, where the adjustment procedure may be based on the control information.

In some examples of the method, apparatuses, network entities, and non-transitory computer-readable medium described herein, the outputting the set of reference signals may include operations, features, means, or instructions for outputting a first set of synchronization signal blocks or a first set of channel state information reference signals, where the set of layer 3 beam measurements correspond to measurements of a second set of synchronization signal blocks or a second set of channel state information reference signals.

### BRIEF DESCRIPTION OF THE DRAWINGS

FIG. 1 shows an example of a wireless communications system that supports layer-3 beam and cell measurement predictions in accordance with one or more aspects of the present disclosure.

FIG. 2 shows an example of a network architecture that supports layer-3 beam and cell measurement predictions in accordance with one or more aspects of the present disclosure.

FIG. 3 shows an example of a beam measurement generation system diagram that supports layer-3 beam and cell measurement predictions in accordance with one or more aspects of the present disclosure.

FIG. 4 shows an example of a wireless communications system that supports layer-3 beam and cell measurement predictions in accordance with one or more aspects of the present disclosure.

FIG. 5 shows an example of a machine learning (ML) process that supports layer-3 beam and cell measurement predictions in accordance with one or more aspects of the present disclosure.

FIG. 6 shows an example of a process flow that supports layer-3 beam and cell measurement predictions in accordance with one or more aspects of the present disclosure.

FIGS. 7 and 8 show block diagrams of devices that support layer-3 beam and cell measurement predictions in accordance with one or more aspects of the present disclosure.

FIG. 9 shows a block diagram of a communications manager that supports layer-3 beam and cell measurement predictions in accordance with one or more aspects of the present disclosure.

FIG. 10 shows a diagram of a system including a device that supports layer-3 beam and cell measurement predictions in accordance with one or more aspects of the present disclosure.

FIGS. 11 and 12 show block diagrams of devices that support layer-3 beam and cell measurement predictions in accordance with one or more aspects of the present disclosure.

FIG. 13 shows a block diagram of a communications manager that supports layer-3 beam and cell measurement predictions in accordance with one or more aspects of the present disclosure.

FIG. 14 shows a diagram of a system including a device that supports layer-3 beam and cell measurement predictions in accordance with one or more aspects of the present disclosure.

FIGS. 15 and 16 show flowcharts illustrating methods that support layer-3 beam and cell measurement predictions in accordance with one or more aspects of the present disclosure.

### DETAILED DESCRIPTION

In some wireless communications systems, a user equipment (UE) may support artificial intelligence (AI) and/or ML-based models and/or functionalities, such as for beam prediction. Such a UE may collect data measurements (e.g., reference signal received power (RSRP) measurements, signal-to-interference-plus-noise-ratio (SINR) measurements, channel impulse response (CIR) measurements, or the like) for one or more directional beams based on measurements of reference signals (e.g., synchronization system blocks (SSBs), channel state information (CSI) reference signals (CSI-RSs), or other reference signals). For example, a UE may measure signals (e.g., SSBs or CSI-RSs) received via directional beams. The UE may train a given AI/ML model/functionality using measurements of a first set of beams of a network entity to predict measurements for a set of second, future beams of the network entity. Further, a trained AI/ML model/functionality may use measurements of a third set of beams to predict measurements for a fourth set of beams, which may be a process referred to as beam inference. AI/ML-based models and/or functionalities may refer to processes or processing frameworks that utilize one or more AI/ML algorithms to perform a given task, such as predicting one or more outputs based on one or more inputs. For instance, an AI/ML-based model and/or functionality may be employed to predict at least one outcome using one or more algorithms applied to a given input pattern. An AI/ML-based model or functionality may therefore support the recognition of patterns and the generation of predictions using input data. In some cases, inference may refer to one or more processes of inputting data to a trained AI/ML model to make predictions. The beams of the network entity whose measurements are predicted or output from the AI/ML model (e.g., the first set of beams or the third set of beams, which may correspond to the same set of beams) may be referred to as set A beams and the beams of the network entity whose measurements are input to the AI/ML model (e.g., the second set of beams or the fourth set of beams, which may correspond to the same set of beams) may be referred to as set B beams. In some examples, predicting measurements may include computing values for measurements of the set of beams without relying on actual measurements performed for the set of beams by the UE.

For example, the UE may use an AI or ML model to determine which beam of the set A beams is most likely (e.g., has the highest probability) to have a best (e.g., highest) layer 1 RSRP (L1-RSRP) value. For example, the UE may send input values (e.g., beam measurements for the set B beams) to an ML algorithm for processing. The ML algorithm may predict beam measurements (e.g., RSRP, SINR, or CIR) for the set A beams based on the measurements for the set B beams. A layer 1 beam measurement may refer to the measurement of a beam in the physical layer (e.g., layer 1). For example, a layer 1 beam measurement may be a measured RSRP, SINR, or CIR of a reference signal received via a given beam. A layer 1 beam prediction may refer to a layer 1 measurement value predicted for a beam (e.g., a set A beam) based on actual measurements of one or more beams (e.g., set B beams). Set A layer 1 beam predictions may be made for different beams (e.g., spatial predictions) than the set B beams or for future measurements (e.g., future temporal predictions). Layer 1 beam measurements may be used to generate layer 3 beam measurements via filtering the layer 1 beam measurements. A layer 3 beam measurement for a beam may refer to the measurement of the beam at the network layer (e.g., layer 3) via filtering of multiple layer 1 beam measurements for the beam, for example, to remove the impact of fast fading and/or to help reduce short term variations in layer 1 beam measurements. For example, the filtering of layer 1 beam measurements to generate a layer 3 beam measurement may involve iteratively applying configured (e.g., radio resource control (RRC) configured) coefficients to a set of multiple layer 1 beam measurements taken over a time period to obtain a longer-term view of the measurement of the beam. Accordingly, layer 3 beam measurements may provide a longer-term view of a beam measurement than layer 1 measurements, and layer 3 beam measurements may be used for radio resource management (RRM) such as triggering of handover procedures. In some cases, where a UE performs layer 1 UE beam predictions, layer 1 beam predictions may be interspersed with layer 1 beam measurements. For example, a UE may perform layer 1 beam measurements, use those layer 1 beam measurements to generate layer 1 beam predictions, and then perform additional layer 1 beam measurements that occur temporally after or are interspersed with the layer 1 beam predictions. How to generate layer 3 beam measurements based on both layer 1 beam measurements and layer 1 beam predictions may be undefined.

Aspects of the present disclosure relate to techniques that may be used to generate layer 3 beam measurements based on layer 1 beam measurements and layer 1 beam predictions. For example, in accordance with one or more aspects of the present disclosure, a UE may perform an adjustment procedure in association with the layer 1 beam predictions when using the layer 1 beam predictions to generate layer 3 beam measurements. For example, a UE may receive a set of one or more reference signals via a set of beams from a network entity, and the UE may perform a set of one or more layer 1 beam measurements on the set of beams based on the reference signals. In some examples, the reference signals may be CSI-RSs. In some examples, the reference signals may be SSBs. The UE may generate, for example, using an AI or ML model and/or functionality, a set of one or more layer 1 beam predictions based on the one or more layer 1 measurements.

The UE may generate a set of layer 3 beam measurements based on the set of layer 1 measurements and the set of layer 1 beam predictions, where the UE may perform an adjustment procedure on the set of one or more layer 1 beam predictions when generating the one or more layer 3 beam measurements. The UE may transmit a report (e.g., a CSI report) that indicates the one or more layer 3 beam measurements. In some examples, the adjustment procedure may be the application of a differing filtering coefficients used in the generation of layer 3 beam measurements to layer 1 beam predictions versus layer 1 beam measurements. In some examples, the adjustment procedure may be the correction of one or more layer 1 beam predictions based on subsequent layer 1 beam measurements. In some examples, the adjustment procedure may be the selection and application of a filtering coefficient based on the quantity of layer 1 beam predictions being used to generate the one or more layer 3 beam measurements (e.g., a ratio of layer 1 beam measurements to layer 1 beam predictions).

By implementing techniques to generate layer 3 beam measurements based on layer 1 beam measurements and layer 1 beam predictions, a UE may more accurately measure layer 3 beam conditions. For example, by using different filtering coefficients for the layer 1 beam predictions and the layer 1 beam measurements, differences in the accuracy of layer 1 beam predictions and layer 1 beam measurements may be accounted for when generating layer 3 beam measurements. For example, as layer 1 beam measurements are representative of actual measurements of signals received by the UE (e.g., the actual measured RSRP, SINR, or CIR of a signal received via a beam), layer 1 beam measurements may be more accurate than layer 1 beam predictions (e.g., which may be AI or ML based predicted RSRP, SINR, or CIR values for a beam). As another example, by selecting a filtering coefficient based on the quantity of layer 1 beam predictions being used to generate the layer 3 beam measurements, differences in the accuracy of layer 1 beam predictions and layer 1 beam measurements may be accounted for when generating layer 3 beam measurements. As another example, by correcting layer 1 beam predictions based on subsequent layer 1 beam measurements prior to generating layer 3 beam measurements, the accuracy of the layer 3 beam measurements may be increased by providing more accurate inputs used to generate the layer 3 beam measurements. By reporting more accurate layer 3 beam measurements, the network may perform RRM determinations and procedures based on more accurate layer 3 beam measurements, thereby improving overall system performance.

Aspects of the disclosure are initially described in the context of wireless communications systems. Aspects of the disclosure are further illustrated by and described with reference to beam measurement generation system diagrams, ML processes, process flows, apparatus diagrams, system diagrams, and flowcharts that relate to layer-3 beam and cell measurement predictions.

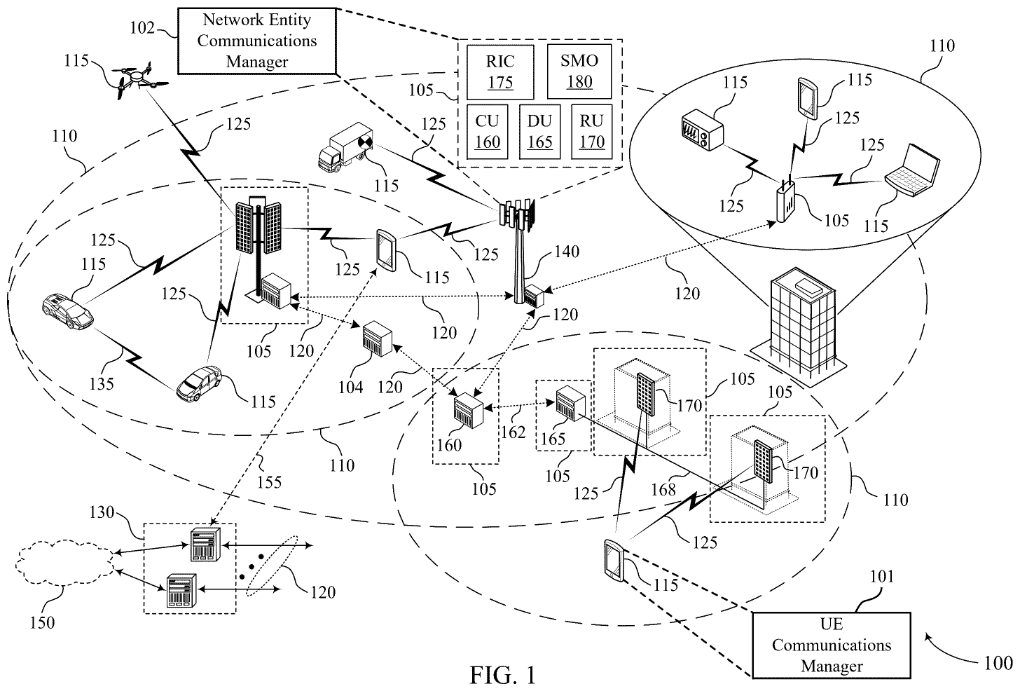

FIG. 1 shows an example of a wireless communications system 100 that supports layer-3 beam and cell measurement predictions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform life cycle management (LCM) operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

Techniques described herein, in addition to or as an alternative to be carried out between UEs 115 and network entities 105, may be implemented via additional or alternative wireless devices, including IAB nodes 104, DUs 165, CUs 160, RUs 170, and the like. For example, in some implementations, aspects described herein may be implemented in the context of a disaggregated RAN architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host L3 (e.g., RRC, SDAP, PDCP, etc.) functionality and signaling. The at least one DU 165 and/or RU 170 may host lower layer, such as L1 and L2 (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FRI (410 MHZ-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, such as a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a UE 115 may measure a first set of beams (“set B beams) and may use measurements of the first set of beams to predict characteristics of a second set of beams (“set A beams”). For example, a UE 115 may predict which beam of a first set of beams, referred to as set A beams, is a best beam for communicating messages with a network entity 105, where the beam being the best beam may refer to the beam being associated with a channel characteristic (e.g., L1-RSRP) that maximizes or minimizes a metric relative to the other beams of the first set of beams. In order to determine which beam of the first set of beams is the best beam, the UE 115 may measure one or more first channel characteristics of a second set of beams, referred to as set B beams, and may use the measurements from the second set of beams and an ML model to generate one or more predicted channel characteristics of the first set of beams. For instance, the UE 115 may measure L1-RSRPs of a first set of one or more reference signals received over the second set of beams and may use an ML model to predict L1-RSRPs of the set A beams.

In some examples, a UE 115 and/or a network entity 105 may perform spatial downlink beam prediction for set A beams using an AI or ML model based on measurement results of set B beams. For example, the set B beams may be wide beams (such as SSB beams) while the set A beams may be narrow beams (such as CSI-RS beams). As another example, the set B beams may be narrow beams (such as CSI-RS beams) while the set A beams may be wide beams (such as SSB beams). In some examples, a UE 115 may perform temporal downlink beam prediction for set A beams using an ML model based on historic measurement results of set B beams. For example, the set A beams and the set B beams may be the same beams at different times (e.g., pure temporal beam predictions). As another example, the set A beams and the set B beams may be different beams at different times (e.g., temporal and spatial beam predictions). In some cases, beam prediction may be performed by one or more UEs 115, by one or more network entities 105, or any combination thereof. In some cases, the beam prediction may be performed for single-cell scenarios.

Layer 3 measurement predictions (e.g., beam and cell level layer 3 measurement prediction) may be obtained, for example, for UE-mobility and other scenarios. In some cases, cell-level measurement prediction may include intra- and inter-frequency measurement predictions (e.g., in a UE-sided and network-sided model). In some cases, inter-cell beam-level measurement predictions may be used for layer 3 mobility (e.g., in the UE-sided and network-sided model). Layer 1 beam measurements may be used to generate layer 3 beam measurements via filtering the layer 1 beam measurements. Layer 3 beam measurements may provide a longer-term view of a beam measurement than layer 1 measurements. Accordingly, layer 3 beam measurements may be used for RRM type decisions and procedures. In some examples, layer 1 beam measurements and layer 1 beam predictions may be used to generate layer 3 beam measurements.

For example, a network communications manager 102 may be configured to output a set of reference signals via a set of beams. The UE communications manager 101 may be configured to receive the set of reference signals. The UE 115 may perform a set of layer 1 measurements on the set of beams based on the set of reference signals. The UE may generate, for example, using an AI or ML model, a set of layer 1 beam predictions based on the layer 1 measurements. The UE 115 may generate a set of layer 3 beam measurements based on the set of layer 1 measurements and the set of layer 1 beam predictions, where the UE 115 may perform an adjustment procedure on the set of layer 1 beam predictions when generating the layer 3 beam measurements. The UE communications manager 101 may be configured to transmit, and the network communications manager 102 may be configured to receive, a report (e.g., a CSI report) that indicates the layer 3 beam measurements. In some examples, the adjustment procedure may be the application of a different filtering coefficient used in the generation of the layer 3 beam measurements to the layer 1 beam predictions than the layer 1 beam measurements. In some examples, the adjustment procedure may be the correction of layer 1 beam predictions based on subsequent layer 1 beam measurements. In some examples, the adjustment procedure may be the selection and application of a filtering coefficient used in the generation of the layer 3 beam measurements based on the quantity of layer 1 beam predictions being used to generate the layer 3 beam measurements (e.g., a ratio of layer 1 beam measurements to layer 1 beam predictions).

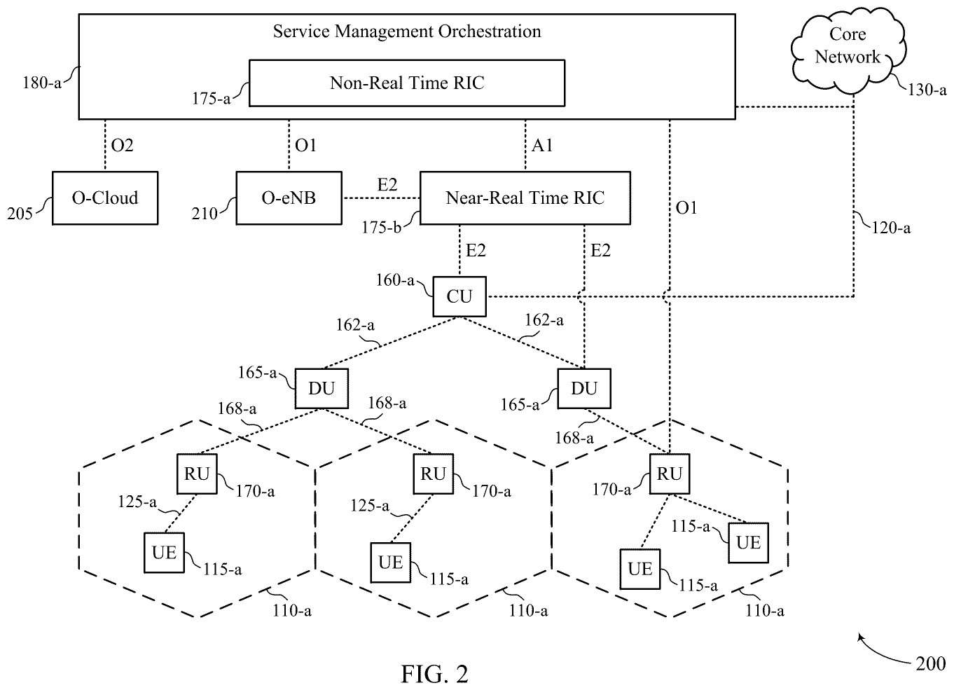

FIG. 2 shows an example of a network architecture 200 (e.g., a disaggregated base station architecture, a disaggregated RAN architecture) that supports layer-3 beam and cell measurement predictions in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, AI or ML workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., Al policies).

The network architecture 200 may support techniques that may be used to generate layer 3 beam measurements based on layer 1 beam measurements and layer 1 beam predictions. For example, a UE 115-a may perform adjustments to the layer 1 beam predictions when using the layer 1 beam predictions to generate layer 3 beam measurements. In some aspects, the UE 115-a may apply different filtering coefficients to the layer 1 beam predictions than to the layer 1 beam measurements when generating the layer 3 beam predictions. In some examples, the network may indicate the filtering coefficients (and an offset) to apply to the layer 1 beam predictions, for example, which may be based on empirical results. In some examples, the network may apply a range of filtering coefficients or a quantity of layer 1 beam predictions to use to generate layer 3 beam measurements, and the UE may select a filtering coefficient or a quantity of the layer 1 beam predictions to use to generate layer 3 beam measurements based on a statistical distribution of the layer 1 beam measurements and the layer 1 beam predictions. In some examples, the filtering coefficient to apply to the layer 1 beam measurements and the layer 1 beam predictions may be selected based on the quantity of layer 1 beam predictions being used to generate the layer 3 beam measurements (e.g., a ratio of layer 1 beam measurements to layer 1 beam predictions). In some examples, the UE may correct layer 1 beam predictions based on subsequent layer 1 beam predictions when generating layer 3 beam predictions. For example, as layer 3 beam measurements are based on multiple past layer 1 beam measurements and predictions, the UE may perform layer 1 beam measurements that correspond to previous layer 1 beam predictions. The UE 115-a may correct those layer 1 beam predictions based on the actual measured values before performing layer 3 beam predictions.

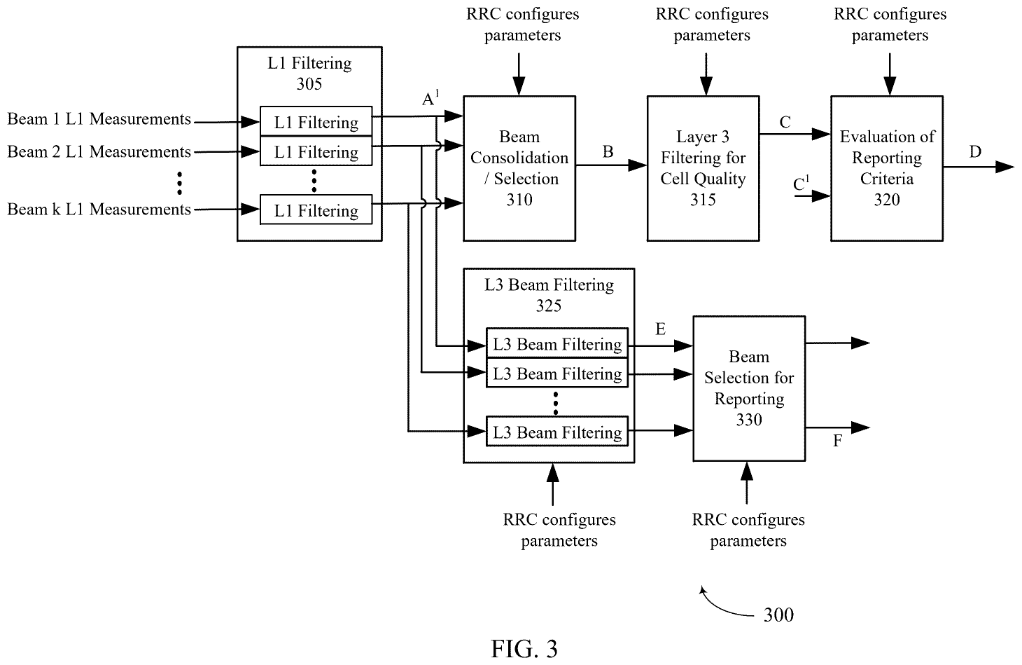

FIG. 3 shows an example of a beam measurement generation system diagram 300 that supports layer-3 beam and cell measurement predictions in accordance with one or more aspects of the present disclosure. The beam measurement generation system diagram 300 may implement or may be implemented by aspects of the wireless communications system 100 or the network architecture 200. For example, the beam measurement generation system may be implemented by a UE 115 as described with reference to FIG. 1 and FIG. 2.

As described herein, a UE 115 may use layer 1 beam measurements to generate a quantity of k layer 3 beam measurements. A quantity k layer 1 beam measurements (e.g., RSRP, SINR, or CIR measurements), where k is the quantity of beams, may be input to a layer 1 filtering component 305. The layer 1 filtering component 305 may receive the layer 1 measurements for each beam and may output a corresponding layer 3 beam measurement for each beam. Accordingly, the layer 1 filtering component 305 may output a set of layer 3 beam measurements, shown as A1 in FIG. 3. The layer 1 filtering component may be UE implementation specific.

In some examples, layer 3 beam and cell measurements may be obtained in accordance with equation 1. For example, for each layer 1 beam, the layer 1 filtering component 305 may use equation 1 to generate a layer 3 beam measurement. In equation 1, Mₙ is the latest received measurement result from the physical layer, Fₙ is the updated filtered measurement result (e.g., the layer 3 beam measurement), Fₙ₋₁ is the last filtered measurement result, and a may be a filtering coefficient. The layer 3 beam measurement Fₙ may be used for evaluation of cell reporting criteria or for layer 3 beam measurement reporting, as described herein. F₀ may be set to M₁ when the first measurement result is received from the physical layer (e.g., M₁ is the first layer 1 beam measurement for a given beam).

$${F}_{n} = ( 1 - a ) * {F}_{n - 1} + a * {M}_{n} \qquad ( 1 )$$

When the layer 3 measurement is used for an RRC configured MeasObjectNR,

$$a = \frac{1}{{2}^{( {k}_{i} \div 4 )}} ,$$

where kᵢ is the RRC parameter filterCoefficient for the corresponding measurement quantity of the i:th QuantityConfigNR in the RRC configured quantityConfigNR-List, and i is indicated by the parameter quantity ConfigIndex in the MeasObjectNR.

For other layer 3 measurements,

$$a = \frac{1}{{2}^{( {k}_{i} \div 4 )}} ,$$

where kᵢ is the RRC parameter filterCoefficient for the corresponding measurement quantity received by the RRC information element (IE) quantityConfig.

For UTRA-FDD,

$$a = \frac{1}{{2}^{( {k}_{i} \div 4 )}} ,$$

where kᵢ is the RRC parameter filterCoefficient for the corresponding measurement quantity indicated by the RRC parameter quantityConfigUTRA-FDD in the IE quantityConfig.

In some examples, the measured beams may be SSBs. For example, the layer 1 beam measurements may be derived from SSBs. In some examples, if the RRC parameter nrofSS-BlocksToAverage is not configured in the associated IE measObject in RRC_CONNECTED mode or in the associated entry in the IE measIdleCarrierListNR within the IE VarMeasIdleConfig in the RRC_IDLE or RRC_INACTIVE modes, if the RRC parameter absThreshSS-BlocksConsolidation is not configured in the associated IE measObject in the RRC_CONNECTED mode or in the associated entry in the IE measIdleCarrierListNR within the IE VarMeasIdleConfig in the RRC_IDLE or RRC_INACTIVE modes, or if the highest beam measurement quantity value is below or equal to the RRC parameter absThreshSS-BlocksConsolidation, then the UE 115 may derive each cell measurement quantity based on the SSB as the highest beam measurement quantity value (e.g., RSRP). Otherwise, the UE 115 may derive each cell measurement quantity based on the SSBs as the linear power scale average of the highest beam measurement quantity values above the RRC parameter absThreshSS-BlocksConsolidation where the total quantity of averaged beams does not exceed the RRC parameter nrofSS-BlocksToAverage.

In some examples, the layer 3 beam measurements may be used for cell quality evaluation. For example, the set of layer 3 beam measurements, A¹, may be input into a beam consolidation and/or selection component 310. The beam consolidation and/or selection component 310 may select a subset of the set of layer 3 beam measurements, where the subset is shown as B in FIG. 3, based on the set of layer 3 beam measurements, A¹, in accordance with one or more RRC configured parameters received from the network. The subset B of the set of layer 3 beam measurements may be input to a layer 3 filtering component 315, which may output a value C based on the subset B of the set of layer 3 beam measurements and based on one or more RRC configured parameters received from the network. The value C may be compared at an evaluation component 320 to reporting criteria, C¹, for the cell, which may be RRC configured from the network. The UE 115 may report the output of the evaluation component, D, to a network entity 105, for example, in a CSI report. For example, the network entity 105 may be an example of a network entity 105 as described with reference to FIG. 1, and the UE 115 may report the output of the evaluation component via a communication link 125 as described with reference to FIG. 1.

In some examples, the layer 3 beam measurements may be used for beam selection and/or reporting. For example, the set of layer 3 beam measurements, A¹, may be input into a layer 3 beam measurement filtering component 325, which may be configured in accordance with one or more RRC parameters received from the network. The layer 3 beam measurement filtering component 325 may output a set of filtered layer 3 beam measurements, shown as E in FIG. 3, where the quantity of filtered layer 3 beam measurements is k. The set of filtered layer 3 beam measurements, E, may be input into a beam selection component 330. The beam selection component 330 may select a quantity of x beams from the set of filtered layer 3 beam measurements based on one or more RRC configured parameters from the network. Thus, the output of the beam selection component 330 may be a set of beams, shown as F in FIG. 3, which the UE 115 may report to a network entity in a beam report. For example, the set of beams, F, may be the best x beams (e.g., the x beams with the highest L3-RSRP) from the k beams based on the set of filtered layer 3 beam measurements, E.

There may be multiple options for coordination between the UE 115 and the network entity 105 for layer 3 beam or cell level measurements. In a first example option, each source/candidate/target/neighbor cell may provide the SSB or CSI-RS set B to measure and the set A to predict for layer 3 beam measurements. In the first example option, UE implementation may determine how the UE 115 measures and predicts the SSB or CSI-RS layer 3 beam or cell measurements. In a second example option, each source/candidate/target/neighbor cell may provide the SSB or CSI-RS set B to measure and the set A to predict for layer 3 beam measurements. In the second example option, the UE 115 may measure the SSB or CSI-RS set (set B) and may predict the SSB or CSI-RS set (set A) layer 1 measurements, and the UE 115 may measure the SSB or CSI-RS beam or cell layer 3 measurement. In the second example option, UE implementation may determine how the UE 115 obtains layer 3 measurements based on the layer 1 SSB or CSI-RS measurements (set B) and the layer 1 SSB or CSI-RS predictions (set A). In a third example option, each source/candidate/target/neighbor cell may provide the SSB or CSI-RS set B to measure and the set A to predict for layer 3 beam measurements. In the third example option, the UE 115 may measure the SSB or CSI-RS set (set B) and may predict the SSB or CSI-RS set (set A) layer 1 measurements, and the UE 115 may measure the SSB or CSI-RS beam or cell layer 3 measurement. In the third example option, the network may configure how the UE obtains the layer 3 measurements based on the layer 1 SSB or CSI-RS measurements (set B) and the layer 1 SSB or CSI-RS predictions (set A).

In some examples, a UE 115 may obtain layer 1 beam measurement samples that are subsequent to a layer 1 beam prediction based on prior layer 1 beam measurement samples, and the UE 115 may generate a layer 3 beam measurement based on the prior layer 1 beam measurement samples, the layer 1 beam predictions, and the subsequent layer 1 beam measurement samples. In some examples, as described herein, the UE 115 may perform an adjustment procedure for layer 1 beam predictions when using layer 1 beam predictions along with layer 1 beam measurements to generate layer 3 beam measurements.

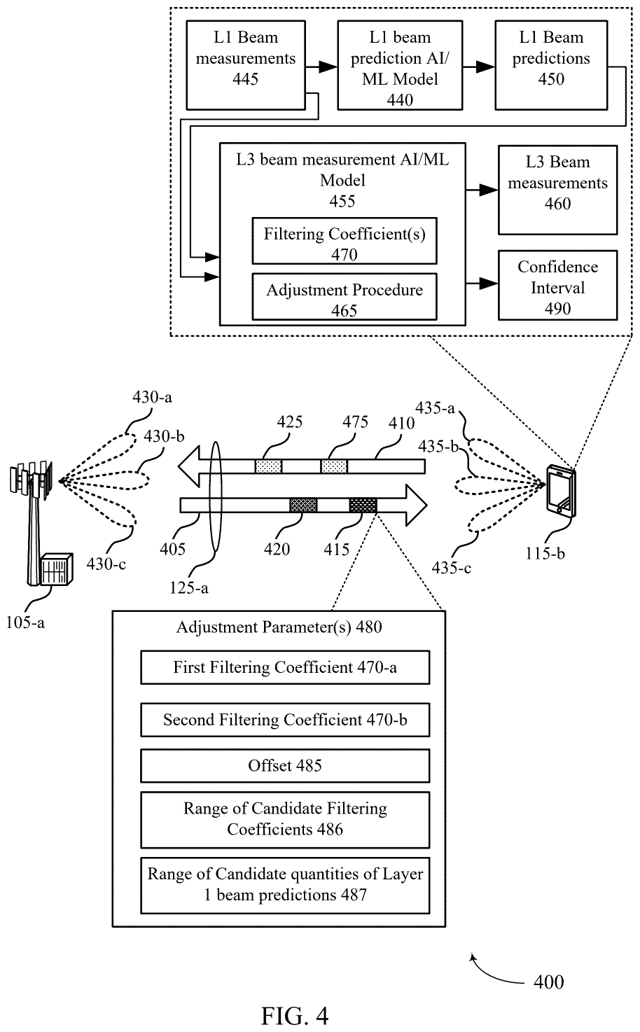

FIG. 4 shows an example of a wireless communications system 400 that supports layer-3 beam and cell measurement predictions in accordance with one or more aspects of the present disclosure. The wireless communications system 400 may implement or may be implemented by aspects of the wireless communications system 100, the network architecture 200, or the beam measurement generation system diagram 300. For example, the wireless communications system 400 may include a UE 115-b, which may be an example of a UE 115 as described herein. The wireless communications system 400 may include a network entity 105-a, which may be an example of a network entity 105 as described herein.

The UE 115-b may communicate with the network entity 105-a using a communication link 125-a. The communication link 125-a may be an example of an NR or LTE link between the UE 115-b and the network entity 105-a. The communication link 125-a may include a bi-directional link that enable both uplink and downlink communications. For example, the UE 115-b may transmit uplink signals 405 (e.g., uplink transmissions), such as uplink control signals or uplink data signals, to the network entity 105-a using the communication link 125-a and the network entity 105-a may transmit downlink signals 410 (e.g., downlink transmissions), such as downlink control signals or downlink data signals, to the UE 115-b using the communication link 125-a.

The network entity 105-a may transmit a set of reference signals 420 (e.g., CSI-RSs or SSBs) to the UE 115-b. The network entity 105-a may use beamforming techniques to transmit the set of reference signals 420 via a set of transmit beams 430 (e.g., a beam 430-a, a beam 430-b, and a beam 430-c as shown in FIG. 4). The UE 115-b may receive the set of reference signals 420 via a set of receive beams 435 (e.g., a beam 435-a, a beam 435-b, and a beam 435-c as shown in FIG. 4) at the UE 115-b that correspond to the set of transmit beams 430. The UE 115-b may perform a set of layer 1 beam measurements 445 on the set of receive beams 435 (e.g., on the reference signals of the set of reference signals received via the set of receive beams 435). The UE 115-b may generate, for example, using a layer 1 beam prediction AI or ML model 440, a set of layer 1 beam predictions 450 based on the layer 1 beam measurements 445. The UE 115-b may generate a set of layer 3 beam measurements 460 based on the set of layer 1 measurements and the set of layer 1 beam predictions, for example, using a layer 3 beam measurement AI or ML model 455. For example, the layer 3 beam measurement AI or ML model 455 may be an example of a layer 1 filtering component 305 as described with reference to FIG. 3. The UE 115-b may transmit a report message 425 that indicates the set of layer 3 beam measurements 460.

To obtain layer 3 measurements (e.g., the layer 3 beam measurements 460) based on the layer 1 measurements and the layer 1 beam predictions 450, filtering coefficients used to generate the layer 3 measurements may be configured such that the layer 3 measurements represent RRM measurement accurately and that the layer 1 measurements (e.g., the layer 1 beam measurements 445 and the layer 1 beam predictions 450) are considered appropriately for obtaining beam and cell level layer 3 measurements. In some examples, similar AI or ML models as the layer 3 beam measurement AI or ML model 455 may be used to generate cell level layer 3 measurements based on cell level layer 1 measurements and cell level layer 1 predictions. In some examples, cell level layer 3 measurements may be generated based on the layer 3 beam measurements, for example, as described with reference to FIG. 3.

In a network-based (e.g., serving and neighbor cell) implementation, the network may indicate adjustment parameters for an adjustment procedure 465 of the layer 3 beam measurement AI or ML model 455, for example, in control information 415. For example, the adjustment parameters may be layer filtering coefficients 470, a cell level configuration, the quantity of predictions to use, or an offset for prediction error. The UE 115-b may use the indicated adjustment parameters in an adjustment procedure 465 of the layer 3 beam measurement AI or ML model 455 to generate the layer 3 beam measurements 460. In a UE-based solution, the UE 115-b may perform the adjustment procedure 465. For example, the UE 115-b may correct a subset of the layer 1 beam predictions 450 based on current (e.g., subsequent) layer 1 beam measurements 445. For example, some of the layer 1 beam predictions 450 may be for a time that is prior to some of the layer 1 beam measurements 445, and, accordingly, the UE 115-b may correct the layer 1 beam predictions 450 based on subsequent layer 1 beam measurements 445 (e.g., whenever possible). As another example, the UE 115-b may dynamically adjust the filtering coefficient(s) 470, cell level configuration, quantity of predictions to use, or offset for prediction error. In some examples, the UE 115-b may transmit assistance information 475 to the network entity 105-a. The assistance information 475 may enable the network entity 105-a to optimize the filtering coefficient(s) 470, cell level configuration, quantity of prediction samples, or offset for prediction error.

In some examples, the UE 115-b may not differentiate the layer 1 beam measurements 445 and the layer 1 beam predictions 450 when generating the layer 3 beam measurements 460 and/or layer 3 cell measurements. For example, when obtaining layer 3 cell measurements from the layer 1 beam measurements in accordance with the RRC parameter nrofSS-BlocksToAverage, the UE 115-b may not differentiate whether the layer 1 beam measurements are actual measurements (e.g., layer 1 beam measurements 445) or predictions (e.g., layer 1 beam predictions 450). As another example, when obtaining layer 3 measurements from layer 1 measurements, the UE 115-b may use the same filtering coefficient for both layer 1 measurements and layer 1 predictions. For example, the layer 3 beam measurement AI or ML model 455 may use the same filtering coefficient 470 for the layer 1 beam measurements 445 and the layer 1 beam predictions 450 to generate the layer 3 beam measurements 460.

In some examples, in a network-based implementation, the measured and predicted values may be differentiated. For example, for obtaining layer 3 measurements (e.g., cell level measurements or layer 3 beam measurements 460) from the layer 1 beam measurements 445 and the layer 1 beam predictions 450, the network may indicate one or more adjustment parameters 480 in control information 415. For example, the network may indicate a first filtering coefficient 470-a and an offset 485 to apply to the layer 1 beam predictions 450 different from a second filtering coefficient 470-b to apply to layer 1 beam measurements 445. For example, before taking the average of layer 1 beam measurement samples (e.g., the layer 1 beam measurements 445 and the layer 1 beam predictions 450) to generate the layer 3 beam measurements 460 (e.g., at the layer 3 beam measurement AI or ML model 455), each layer 1 beam measurement 445 may be multiplied by the second filtering coefficient 470-b, and each layer 1 beam prediction 450 may be multiplied by the first filtering coefficient 470-a and then added with an offset 485. For example, the second filtering coefficient 470-b may be “1,” the first filtering coefficient 470-a may be a discount factor, and the offset 485 may be an offset for error correction if the layer 1 beam measurement sample is a layer 1 beam prediction 450 (e.g., of an SSB or CSI-RS).

In some examples, the control information 415 may indicate a range of candidate filtering coefficients 486, from which the UE 115-b may select the filtering coefficient(s) 470. For example, the UE 115-b may calculate, determine, or generate a confidence interval associated with each layer 1 beam prediction 450, and the filtering coefficient 470 applied to a given layer 1 beam prediction 450 may be selected from the range of candidate filtering coefficients 486 based on the confidence interval associated with the given layer 1 beam predictions as part of the adjustment procedure 465. For example, lower weight (e.g., a lower filtering coefficient 470) may be applied to a layer 1 beam prediction 450 with a higher confidence interval.

In some examples, the filtering coefficient 470 used to generate the layer 3 measurements may be a function of the quantity of the layer 1 beam predictions used to generate the layer 3 measurements. For example, if layer 3 measurements (e.g., layer 3 cell measurements or layer 3 beam measurements 460) are obtained using a large quantity of layer 1 beam predictions 450 (e.g., as compared to layer 1 beam measurements 445), a different filtering coefficient 470 may be used than when a small quantity of layer 1 beam predictions 450 are used to obtain the layer 3 beam measurements 460. For example, assuming N samples are predictions out of M total measurement samples used to generate a layer 3 measurement, then the layer 1 measurement samples may have N/M*γ, where γ is a filtering coefficient for generating layer 3 measurements.

In some examples, the control information 415 may indicate a frequency for the UE 115-b to update layer 3 measurements (e.g., the layer 3 beam measurements 460) based on predicted values (e.g., the layer 1 beam predictions 450). For example, the UE 115-b may indicate the confidence intervals associated with the layer 1 beam predictions 450 in assistance information 475, and based on the reported confidence intervals, the network entity 105-b may indicate the frequency for the UE 115-b to update layer 3 measurements based on predicted values. For example, the control information 415 may configure the UE 115-b to use a lower quantity of layer 1 beam predictions 450 to generate layer 3 beam measurements if the confidence interval of the layer 1 beam predictions 450 is low.

In some examples, the UE 115-b may report a confidence interval 490 for the layer 3 beam measurement in the assistance information 475 or the report message 425. The confidence interval 490 may be calculated, obtained, determined, or generated as the average or standard deviation across confidence intervals for the layer 1 beam predictions 450 and the layer 1 beam measurements 445, where a layer 1 beam measurement 445 may be 0. In some examples, the confidence interval 490 may be calculated, obtained, determined, or generated by considering the prediction as a random process.

In some examples, as part of the adjustment procedure 465, whenever possible, the UE 115-b may correct previous layer 1 beam predictions 450 based on current and/or previous layer 1 beam measurements 445 (e.g., layer 1 beam measurements 445 subsequent to the previous layer 1 beam predictions 450) prior to using the layer 1 beam predictions 450 to generate the layer 3 beam measurements 460. For example, the UE 115-b may recompute SSB and/or CSI-RS layer 3 measurements and/or layer 1 or layer 3 cell level measurements before including the measurements in the report message 425. For example, the UE 115-b may predict SSB or CSI-RS beam or cell measurements at {t_{K}, t_{K+1}, . . . , t_{L}}. The UE 115-b may measure SSB or CSI-RS beam or cell measurements at {t_{M}, t_{M+1}> . . . , t_{N}}, where t_{M}>t_{L}. The UE 115-b may attempt to correct previous predicted values based on the new measurements, which corrections may apply to temporal, spatial, temporal+spatial beam or cell measurements, and/or inter-frequency measurement predictions. For spatial, inter-frequency, and temporal+spatial beam or cell predictions, an SSB or CSI-RS may be configured to be predicted between {t_{K}, t_{K+1}, . . . , t_{L}}, and measured between {t_{M}, t_{M+1}, . . . , t_{N}}. The UE 115-b may correct the predicted measurements in {t_{K}, t_{K+1}, . . . , t_{L}}, based on measurements in {M, t_{M+1}, . . . , t_{N}}. In some examples, the network entity 105-a may indicate, in the control information 415, whether the UE 115-b should attempt to correct previous predictions (e.g., layer 1 beam predictions 450). In some examples, the network entity 105-a may indicate, in the control information 415, the quantity of predictions prior to the current sample measurement that the UE 115-b should attempt to correct.

In some examples, as part of the adjustment procedure 465 the UE 115-b may dynamically adjust the filtering coefficient(s) 470 and/or quantity of prediction samples (e.g., layer 1 beam predictions 450) used to generate the layer 3 measurements based on a statistical distribution of the layer 1 beam predictions 450 and/or a statistical distribution of the layer 3 measurements (e.g., the layer 3 beam measurements 460 and/or other layer 3 cell measurements). For example, the control information 415 may indicate a range of candidate filtering coefficients 486, a range of quantities of layer 1 beam predictions 487 to use to generate layer 3 measurements, or cell configurations, which the UE 115-b may select from as part of the adjustment procedure 465. In some examples, based on performance monitoring at the UE 115-b, the UE 115-b may indicate a recommended filtering coefficient or a recommended configuration for cell level measurements in the assistance information 475.

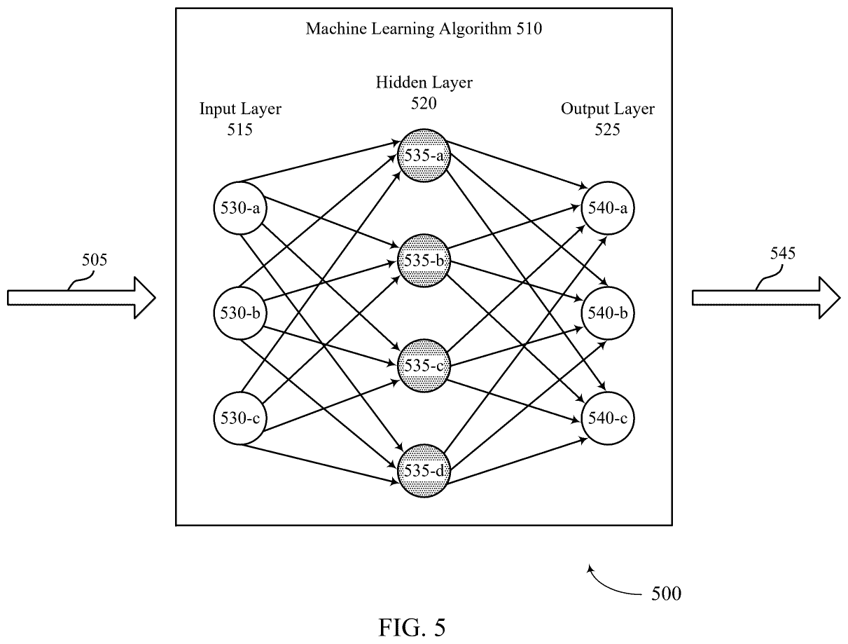

FIG. 5 shows an example of an ML process 500 that supports layer-3 beam and cell measurement predictions in accordance with one or more aspects of the present disclosure. The ML process 500 may be implemented at a network entity 105, or a UE 115, or both as described with reference to FIGS. 1 through 4.

The ML process 500 may include an ML algorithm 510. As illustrated, the ML algorithm 510 may be an example of a neural network, such as a feed forward (FF) or deep feed forward (DFF) neural network, a recurrent neural network (RNN), a long/short term memory (LSTM) neural network, or any other type of neural network. However, any other ML algorithms may be supported. For example, the ML algorithm 510 may implement a nearest neighbor algorithm, a linear regression algorithm, a Naïve Bayes algorithm, a random forest algorithm, or any other ML algorithm. Further, the ML process 500 may involve supervised learning, unsupervised learning, semi-supervised learning, reinforcement learning, or any combination thereof.

The ML algorithm 510 may include an input layer 515, one or more hidden layers 520, and an output layer 525. In a fully connected neural network with one hidden layer 520, each hidden layer node 535 may receive a value from each input layer node 530 as input, where each input may be weighted. These neural network weights may be based on a cost function that is revised during training of the ML algorithm 510. Similarly, each output layer node 540 may receive a value from each hidden layer node 535 as input, where the inputs are weighted. If post-deployment training (e.g., online training) is supported, memory may be allocated to store errors and/or gradients for reverse matrix multiplication. These errors and/or gradients may support updating the ML algorithm 510 based on output feedback. Training the ML algorithm 510 may support computation of the weights (e.g., connecting the input layer nodes 530 to the hidden layer nodes 535 and the hidden layer nodes 535 to the output layer nodes 540) to map an input pattern to a desired output outcome. This training may result in a device-specific ML algorithm 510 based on the historic application data and data transfer for a specific network entity 105 or UE 115.

In some examples, input values 505 may be sent to the ML algorithm 510 for processing. In some examples, preprocessing may be performed according to a sequence of operations on the input values 505 such that the input values 505 may be in a format that is compatible with the ML algorithm 510. The input values 505 may be converted into a set of k input layer nodes 530 at the input layer 515. In some cases, different measurements may be input at different input layer nodes 530 of the input layer 515. Some input layer nodes 530 may be assigned default values (e.g., values of 0) if the quantity of input layer nodes 530 exceeds the quantity of inputs corresponding to the input values 505. As illustrated, the input layer 515 may include three input layer nodes 530-a, 530-b, and 530-c. However, it is to be understood that the input layer 515 may include any quantity of input layer nodes 530 (e.g., 20 input nodes).

The ML algorithm 510 may convert the input layer 515 to a hidden layer 520 based on a quantity of input-to-hidden weights between the k input layer nodes 530 and the n hidden layer nodes 535. The ML algorithm 510 may include any quantity of hidden layers 520 as intermediate steps between the input layer 515 and the output layer 525. Additionally, each hidden layer 520 may include any quantity of nodes. For example, as illustrated, the hidden layer 520 may include four hidden layer nodes 535-a, 535-b, 535-c, and 535-d. However, it is to be understood that the hidden layer 520 may include any quantity of hidden layer nodes 535 (e.g., 10 input nodes). In a fully connected neural network, each node in a layer may be based on each node in the previous layer. For example, the value of hidden layer node 535-a may be based on the values of input layer nodes 530-a, 530-b, and 530-c (e.g., with different weights applied to each node value).

The ML algorithm 510 may determine values for the output layer nodes 540 of the output layer 525 following one or more hidden layers 520. For example, the ML algorithm 510 may convert the hidden layer 520 to the output layer 525 based on a quantity of hidden-to-output weights between the n hidden layer nodes 535 and the m output layer nodes 540. In some cases, n=m. Each output layer node 540 may correspond to a different output value 545 of the ML algorithm 510. As illustrated, the ML algorithm 510 may include three output layer nodes 540-a, 540-b, and 540-c, supporting three different threshold values. However, it is to be understood that the output layer 525 may include any quantity of output layer nodes 540. In some examples, post-processing may be performed on the output values 545 according to a sequence of operations such that the output values 545 may be in a format that is compatible with reporting the output values 545.

In some examples, the ML algorithm 510 may be used to predict beam measurements (e.g., RSPR, SINR, or CIR) for a first set of beams (set A) based on measurements (e.g., RSPR, SINR, or CIR) for a second set of beams (set B). In some examples, the ML algorithm 510 may be used to generate layer 3 beam measurements based on layer 1 beam measurements. As such, the ML algorithm 510 may support techniques that may be used to generate layer 3 beam measurements based on layer 1 beam measurements and layer 1 beam predictions. For example, a UE 115 may perform adjustments to the layer 1 beam predictions when using the layer 1 beam predictions to generate layer 3 beam measurements. In some aspects, a UE 115 implementing one or more ML algorithms 510 may apply different filtering coefficients to the layer 1 beam predictions than to the layer 1 beam measurements when generating the layer 3 beam predictions. In some examples, the network may indicate the filtering coefficients (and an offset) to apply to the layer 1 beam predictions, for example, which may be based on empirical results. In some examples, the network may apply a range of filtering coefficients or a quantity of layer 1 beam predictions to use to generate layer 3 beam measurements, and the UE 115 may select a filtering coefficient or a quantity of the layer 1 beam predictions to use to generate layer 3 beam measurements based on a statistical distribution of the layer 1 beam measurements and the layer 1 beam predictions. In some examples, the filtering coefficient to apply to the layer 1 beam measurements and the layer 1 beam predictions may be selected based on the quantity of layer 1 beam predictions being used to generate the layer 3 beam measurements (e.g., a ratio of layer 1 beam measurements to layer 1 beam predictions). In some examples, the UE 115 may correct layer 1 beam predictions based on subsequent layer 1 beam predictions when generating layer 3 beam predictions. For example, as layer 3 beam measurements are based on multiple past layer 1 beam measurements and predictions, the UE may perform layer 1 beam measurements that correspond to previous layer 1 beam predictions. The UE 115 may correct those layer 1 beam predictions based on the actual measured values before performing layer 3 beam predictions.

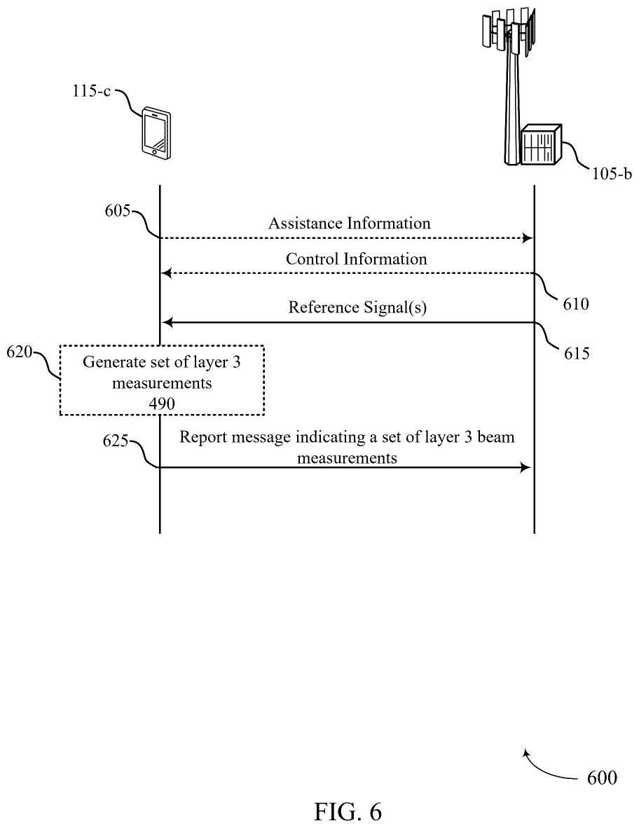

FIG. 6 shows an example of a process flow 600 that supports layer-3 beam and cell measurement predictions in accordance with one or more aspects of the present disclosure. The process flow 600 may implement or may be implemented by aspects of the wireless communications system 100, the network architecture 200, the beam measurement generation system diagram 300, the wireless communications system 400, or the ML process 500. For example, the process flow 600 may include a UE 115-c, which may be an example of a UE 115 as described herein. The process flow 600 may also include a network entity 105-b, which may be an example of a network entity 105 as described herein. In the following description of the process flow 600, the operations between the network entity 105-b and the UE 115-c may be transmitted in a different order than the example order shown, or the operations performed by the network entity 105-b and the UE 115-c may be performed in different orders or at different times. Some operations may also be omitted from the process flow 600, and other operations may be added to the process flow 600.

At 615, the network entity 105-b may output, and the UE 115-c may receive, a set of reference signals.

At 625, the UE 115-c may transmit, and the network entity 105-b may obtain, a report message indicating a set of layer 3 beam measurements. The set of layer 3 beam measurements may be based on a set of layer 1 beam measurements and may be based on an adjustment procedure for a set of layer 1 beam predictions. The set of layer 1 beam measurements may be generated based on the set of reference signals, and the set of layer 1 beam predictions may be generated based on the set of layer 1 beam measurements.

In some examples, at 610, the network entity 105-b may output, and the UE 115-c may receive, control information that indicates one or more adjustment parameters associated with layer 1 beam predictions. In such examples, the adjustment procedure may be based on the one or more adjustment parameters. In some examples, the one or more adjustment parameters include a first filtering coefficient value and an offset value. In some examples, at 620, the UE 115-c may generate the set of layer 3 beam measurements based on multiplication of the set of layer 1 beam predictions by the first filtering coefficient value and addition of the offset value. In some examples, the network entity 105-b may output, and the UE 115-c may receive, via the control information, an indication of a second filtering coefficient value associated with layer 1 beam measurements, the second filtering coefficient value different from the first filtering coefficient value. In such examples, the set of layer 3 beam measurements may be generated at 620 based on multiplication of the set of layer 1 beam measurements by the second filtering coefficient value. In some examples, the one or more adjustment parameters may include a set of filtering coefficient values associated with the layer 1 beam predictions and layer 1 beam measurements for layer 3 beam measurements, and the set of layer 3 beam measurements may be generated at 620 based on (e.g., using) a filtering coefficient value of the set of filtering coefficient values selected based on a quantity of layer 1 beam predictions of the set of layer 1 beam predictions. In some examples, the control information at 610 indicates the one or more adjustment parameters for each carrier frequency of a set of carrier frequencies, for each radio access technology of a set of radio access technologies, or for each cell of a set of cells. In some examples, at 605, the UE 115-c may transmit, and the network entity 105-b may obtain, assistance information that indicates a recommended filtering coefficient value based on a set of prior layer 3 beam measurements generated by the UE 115-c, and reception of the control information at 610 may be based on the assistance information.

In some examples, UE 115-c may transmit, and the network entity 105-b may obtain, an indication of a confidence interval associated with the set of layer 3 beam measurements.

In some examples, UE 115-c may modify one or more layer 1 beam predictions of the set of layer 1 beam predictions based on subsequent layer 1 beam measurements corresponding to the one or more layer 1 beam predictions, where the subsequent layer 1 beam measurements are a subset of the set of layer 1 beam measurements, and where the adjustment procedure involves modifying the one or more layer 1 beam predictions. In some examples, at 610, the network entity 105-b may output, and the UE 115-c may receive, control information including an indication to modify the set of layer 1 beam predictions based on the subsequent layer 1 beam measurements, and the modifying the one or more layer 1 beam predictions of the set of layer 1 beam predictions is based on the control information.

In some examples, UE 115-c may select, based on a distribution of the set of layer 1 beam measurements and the set of layer 1 beam predictions, a filtering coefficient value for application to layer 1 beam predictions and layer 1 beam measurements for generation of layer 3 beam measurements, a quantity of layer 3 beam measurements to include in the set of layer 3 beam measurements, or both. In some examples, at 610, the network entity 105-b may output, and the UE 115-c may receive, control information that indicates a range of candidate filtering coefficient values, a range of candidate quantities of layer 3 beam measurements, or both, and the selecting is based on the control information.

In some examples, the set of reference signals at 615 may be a first set of SSBs or a first set of CSI-RSs, and the set of layer 3 beam measurements may correspond to measurements of a second set of SSBs or a second set of CSI-RSs.

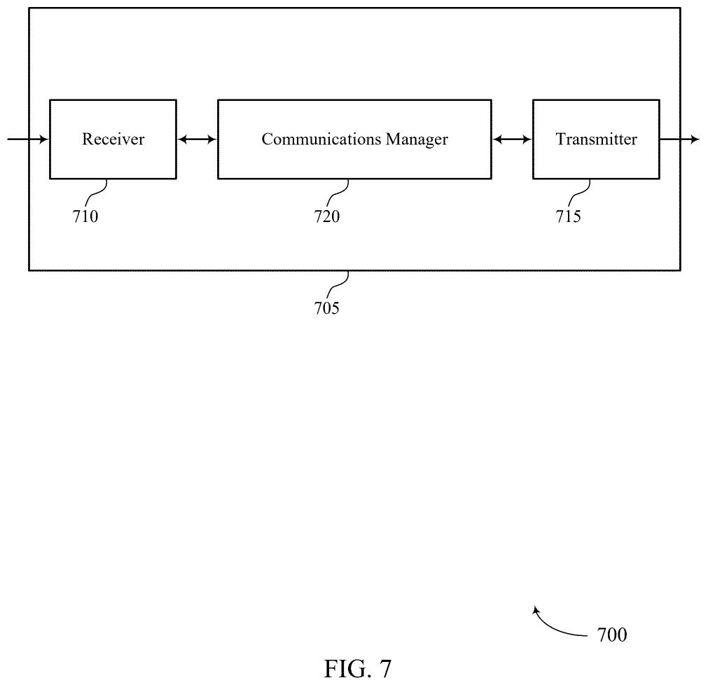

FIG. 7 shows a block diagram 700 of a device 705 that supports layer-3 beam and cell measurement predictions in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to layer-3 beam and cell measurement predictions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to layer-3 beam and cell measurement predictions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of layer-3 beam and cell measurement predictions as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a set of reference signals. The communications manager 720 is capable of, configured to, or operable to support a means for transmitting a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

The communications manager 720 may be an example of means for performing various aspects of layer 3 measurement generation and reporting based on an availability of beam prediction monitoring reference signals as described herein. The communications manager 720, or its sub-components, may be implemented in hardware (e.g., in communications management circuitry). The circuitry may comprise of processor, DSP, an ASIC, an FPGA or other programmable logic device, discrete gate or transistor logic, discrete hardware components, or any combination thereof designed to perform the functions described in the present disclosure.

In another implementation, the communications manager 720, or its sub-components, may be implemented in code (e.g., as communications management software or firmware) executed by a processor, or any combination thereof. If implemented in code executed by a processor, the functions of the communications manager 720, or its sub-components may be executed by a general-purpose processor, a DSP, an ASIC, an FPGA or other programmable logic device.

In some examples, the communications manager 720 may be configured to perform various operations (e.g., receiving, determining, transmitting) using or otherwise in cooperation with the receiver 710, the transmitter 715, or both.

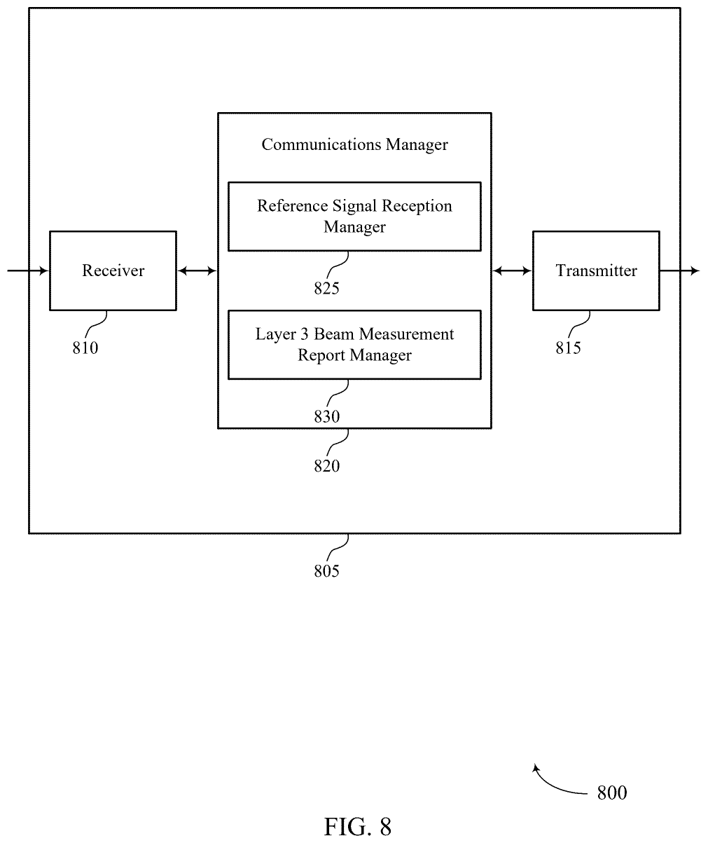

FIG. 8 shows a block diagram 800 of a device 805 that supports layer-3 beam and cell measurement predictions in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to layer-3 beam and cell measurement predictions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to layer-3 beam and cell measurement predictions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of layer-3 beam and cell measurement predictions as described herein. For example, the communications manager 820 may include a reference signal reception manager 825 a layer 3 beam measurement report manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The reference signal reception manager 825 is capable of, configured to, or operable to support a means for receiving a set of reference signals. The layer 3 beam measurement report manager 830 is capable of, configured to, or operable to support a means for transmitting a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

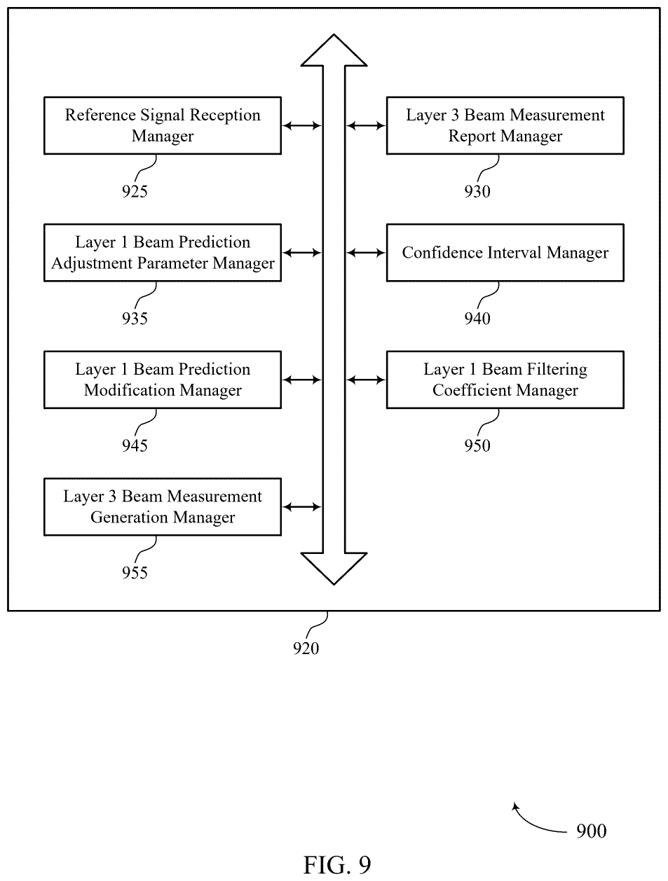

FIG. 9 shows a block diagram 900 of a communications manager 920 that supports layer-3 beam and cell measurement predictions in accordance with one or more aspects of the present disclosure. The communications manager 920 may be an example of aspects of a communications manager 720, a communications manager 820, or both, as described herein. The communications manager 920, or various components thereof, may be an example of means for performing various aspects of layer-3 beam and cell measurement predictions as described herein. For example, the communications manager 920 may include a reference signal reception manager 925, a layer 3 beam measurement report manager 930, a layer 1 beam prediction adjustment parameter manager 935, a confidence interval manager 940, a layer 1 beam prediction modification manager 945, a layer 1 beam filtering coefficient manager 950, a layer 3 beam measurement generation manager 955, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The reference signal reception manager 925 is capable of, configured to, or operable to support a means for receiving a set of reference signals. The layer 3 beam measurement report manager 930 is capable of, configured to, or operable to support a means for transmitting a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

In some examples, the layer 1 beam prediction adjustment parameter manager 935 is capable of, configured to, or operable to support a means for receiving, from a network entity, control information that indicates one or more adjustment parameters associated with layer 1 beam predictions, the adjustment procedure based on the one or more adjustment parameters.

In some examples, the one or more adjustment parameters include a first filtering coefficient value and an offset value.

In some examples, the layer 3 beam measurement generation manager 955 is capable of, configured to, or operable to support a means for generating the set of layer 3 beam measurements based on multiplication of the set of layer 1 beam predictions by the first filtering coefficient value and addition of the offset value.

In some examples, the layer 1 beam filtering coefficient manager 950 is capable of, configured to, or operable to support a means for receiving, via the control information, an indication of a second filtering coefficient value associated with layer 1 beam measurements, the second filtering coefficient value different from the first filtering coefficient value, where the set of layer 3 beam measurements is generated based on multiplication of the set of layer 1 beam measurements by the second filtering coefficient value.

In some examples, the one or more adjustment parameters include a set of filtering coefficient values associated with the layer 1 beam predictions and layer 1 beam measurements for layer 3 beam measurements. In some examples, the set of layer 3 beam measurements are generated based on a filtering coefficient value of the set of filtering coefficient values selected based on a quantity of layer 1 beam predictions of the set of layer 1 beam predictions.

In some examples, the control information indicates the one or more adjustment parameters for each carrier frequency of a set of carrier frequencies, for each radio access technology of a set of radio access technologies, or for each cell of a set of cells.

In some examples, the layer 1 beam filtering coefficient manager 950 is capable of, configured to, or operable to support a means for transmitting, to the network entity, assistance information that indicates a recommended filtering coefficient value based on a set of prior layer 3 beam measurements generated by the UE, where reception of the control information is based on the assistance information.

In some examples, to support transmitting the report message, the confidence interval manager 940 is capable of, configured to, or operable to support a means for transmitting an indication of a confidence interval associated with the set of layer 3 beam measurements.

In some examples, the layer 1 beam prediction modification manager 945 is capable of, configured to, or operable to support a means for modifying one or more layer 1 beam predictions of the set of layer 1 beam predictions based on subsequent layer 1 beam measurements corresponding to the one or more layer 1 beam predictions, where the subsequent layer 1 beam measurements are a subset of the set of layer 1 beam measurements, and where the adjustment procedure includes the modifying the one or more layer 1 beam predictions.

In some examples, the layer 1 beam prediction modification manager 945 is capable of, configured to, or operable to support a means for receiving, from a network entity, control information including an indication to modify the set of layer 1 beam predictions based on the subsequent layer 1 beam measurements, where the modifying the one or more layer 1 beam predictions of the set of layer 1 beam predictions is based on the control information.

In some examples, the control information further indicates a quantity of layer 1 beam predictions to modify.

In some examples, the layer 1 beam filtering coefficient manager 950 is capable of, configured to, or operable to support a means for selecting, based on a distribution of the set of layer 1 beam measurements and the set of layer 1 beam predictions, a filtering coefficient value for application to layer 1 beam predictions and layer 1 beam measurements for generation of layer 3 beam measurements, a quantity of layer 3 beam measurements to include in the set of layer 3 beam measurements, or both.

In some examples, the layer 1 beam filtering coefficient manager 950 is capable of, configured to, or operable to support a means for receiving, from a network entity, control information that indicates a range of candidate filtering coefficient values, a range of candidate quantities of layer 3 beam measurements, or both, where the selecting is based on the control information.

In some examples, to support receiving the set of reference signals, the reference signal reception manager 925 is capable of, configured to, or operable to support a means for receiving a first set of SSBs or a first set of CSI-RSs, where the set of layer 3 beam measurements correspond to measurements of a second set of SSBs or a second set of CSI-RSs.

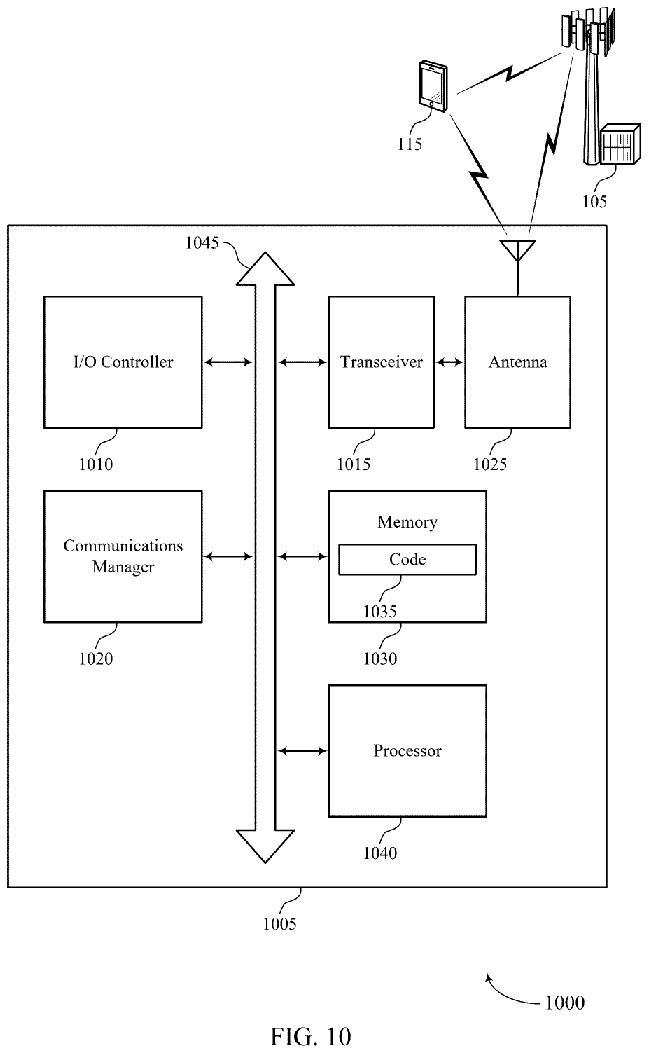

FIG. 10 shows a diagram of a system 1000 including a device 1005 that supports layer-3 beam and cell measurement predictions in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting layer-3 beam and cell measurement predictions). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a set of reference signals. The communications manager 1020 is capable of, configured to, or operable to support a means for transmitting a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

By including or configuring the communications manager 1020 in accordance with examples as described herein, the device 1005 may support techniques for more efficient utilization of communication resources, improved coordination between devices, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of layer-3 beam and cell measurement predictions as described herein, or the at least one processor 1040 and the at least one memory 1030 may be otherwise configured to, individually or collectively, perform or support such operations.

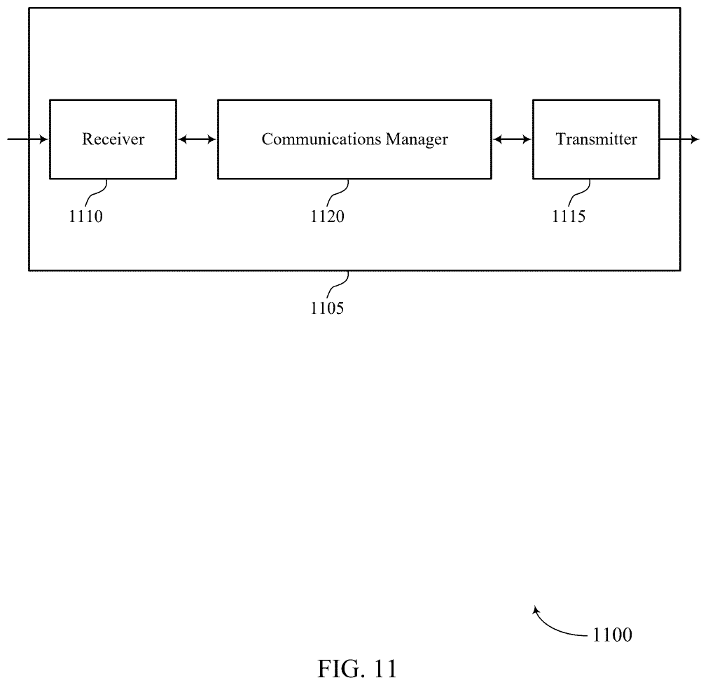

FIG. 11 shows a block diagram 1100 of a device 1105 that supports layer-3 beam and cell measurement predictions in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of layer-3 beam and cell measurement predictions as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting a set of reference signals. The communications manager 1120 is capable of, configured to, or operable to support a means for obtaining a report message indicating a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

The communications manager 1120 may be an example of means for performing various aspects of layer 3 measurement generation and reporting based on an availability of beam prediction monitoring reference signals as described herein. The communications manager 1120, or its sub-components, may be implemented in hardware (e.g., in communications management circuitry). The circuitry may comprise of processor, DSP, an ASIC, an FPGA or other programmable logic device, discrete gate or transistor logic, discrete hardware components, or any combination thereof designed to perform the functions described in the present disclosure.

In another implementation, the communications manager 1120, or its sub-components, may be implemented in code (e.g., as communications management software or firmware) executed by a processor, or any combination thereof. If implemented in code executed by a processor, the functions of the communications manager 1120, or its sub-components may be executed by a general-purpose processor, a DSP, an ASIC, an FPGA or other programmable logic device.

In some examples, the communications manager 1120 may be configured to perform various operations (e.g., receiving, determining, transmitting) using or otherwise in cooperation with the receiver 1110, the transmitter 1115, or both.

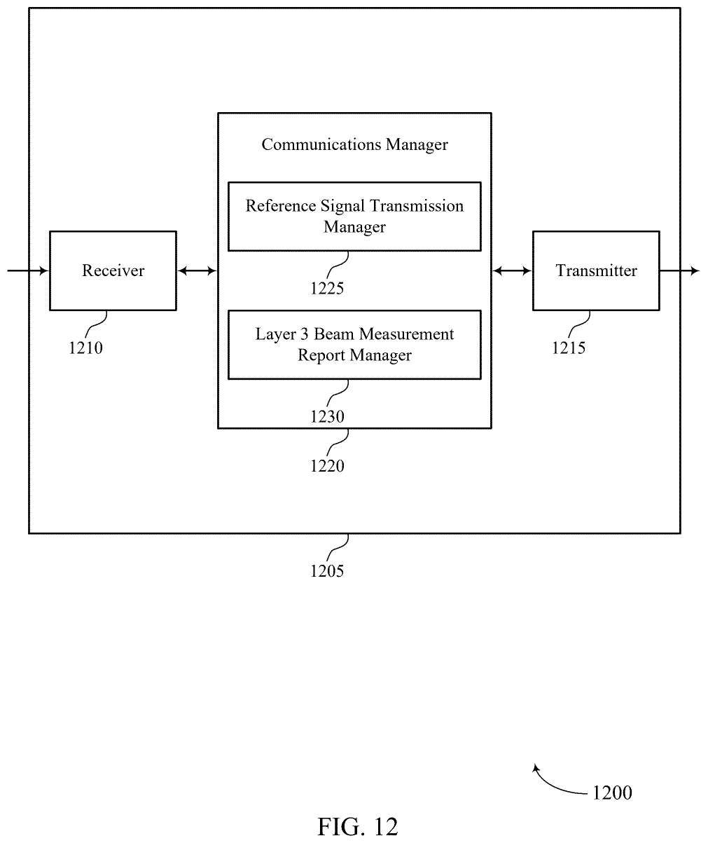

FIG. 12 shows a block diagram 1200 of a device 1205 that supports layer-3 beam and cell measurement predictions in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of layer-3 beam and cell measurement predictions as described herein. For example, the communications manager 1220 may include a reference signal transmission manager 1225 a layer 3 beam measurement report manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The reference signal transmission manager 1225 is capable of, configured to, or operable to support a means for outputting a set of reference signals. The layer 3 beam measurement report manager 1230 is capable of, configured to, or operable to support a means for obtaining a report message indicating a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

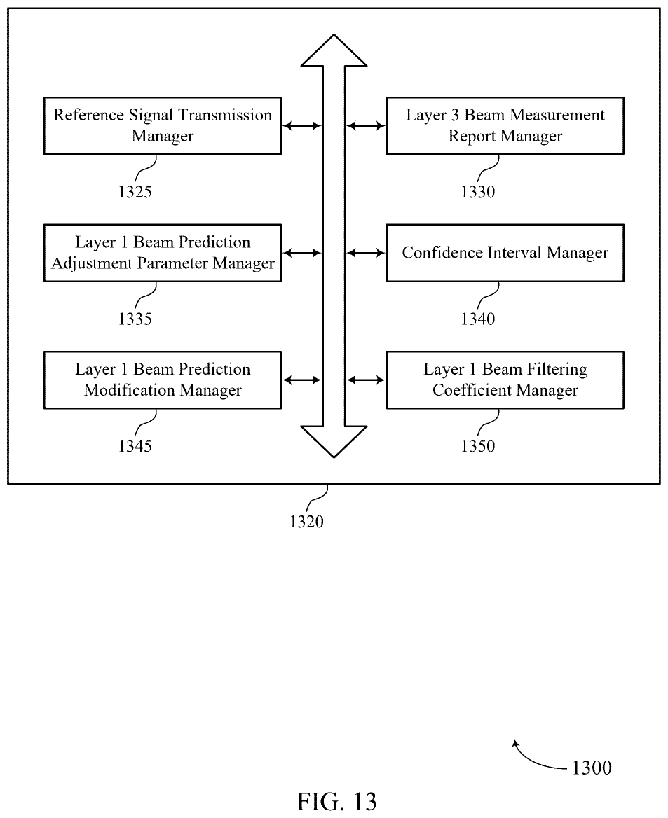

FIG. 13 shows a block diagram 1300 of a communications manager 1320 that supports layer-3 beam and cell measurement predictions in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of layer-3 beam and cell measurement predictions as described herein. For example, the communications manager 1320 may include a reference signal transmission manager 1325, a layer 3 beam measurement report manager 1330, a layer 1 beam prediction adjustment parameter manager 1335, a confidence interval manager 1340, a layer 1 beam prediction modification manager 1345, a layer 1 beam filtering coefficient manager 1350, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The reference signal transmission manager 1325 is capable of, configured to, or operable to support a means for outputting a set of reference signals. The layer 3 beam measurement report manager 1330 is capable of, configured to, or operable to support a means for obtaining a report message indicating a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

In some examples, the layer 1 beam prediction adjustment parameter manager 1335 is capable of, configured to, or operable to support a means for outputting, for the UE, control information that indicates one or more adjustment parameters associated with layer 1 beam predictions, the adjustment procedure based on the one or more adjustment parameters.

In some examples, the one or more adjustment parameters include a first filtering coefficient value and an offset value.

In some examples, the set of layer 3 beam measurements are generated based on multiplication of the set of layer 1 beam predictions by the first filtering coefficient value and addition of the offset value.

In some examples, the layer 1 beam filtering coefficient manager 1350 is capable of, configured to, or operable to support a means for outputting, via the control information, an indication of a second filtering coefficient value associated with layer 1 beam measurements, the second filtering coefficient value different from the first filtering coefficient value, where the set of layer 3 beam measurements is generated based on multiplication of the set of layer 1 beam measurements by the second filtering coefficient value.

In some examples, the one or more adjustment parameters include a set of filtering coefficient values associated with the layer 1 beam predictions and layer 1 beam measurements for layer 3 beam measurements. In some examples, the set of layer 3 beam measurements are generated based on a filtering coefficient value of the set of filtering coefficient values selected based on a quantity of layer 1 beam predictions of the set of layer 1 beam predictions.

In some examples, the control information indicates the one or more adjustment parameters for each carrier frequency of a set of carrier frequencies, for each radio access technology of a set of radio access technologies, or for each cell of a set of cells.

In some examples, the layer 1 beam filtering coefficient manager 1350 is capable of, configured to, or operable to support a means for obtaining assistance information that indicates a recommended filtering coefficient value from the UE based on a set of prior layer 3 beam measurements associated with (e.g., generated by) the UE, where transmission of the control information is based on the assistance information.

In some examples, to support obtaining the report message, the confidence interval manager 1340 is capable of, configured to, or operable to support a means for obtaining an indication of a confidence interval associated with the set of layer 3 beam measurements.

In some examples, the layer 1 beam prediction modification manager 1345 is capable of, configured to, or operable to support a means for outputting, for the UE, control information including an indication to modify the set of layer 1 beam predictions based on subsequent layer 1 beam measurements, where the adjustment procedure is based on the control information.

In some examples, the control information further indicates a quantity of layer 1 beam predictions to modify.

In some examples, the layer 1 beam filtering coefficient manager 1350 is capable of, configured to, or operable to support a means for outputting, for the UE, control information that indicates a range of candidate filtering coefficient values, a range of candidate quantities of layer 3 beam measurements, or both, where the adjustment procedure is based on the control information.

In some examples, to support outputting the set of reference signals, the reference signal transmission manager 1325 is capable of, configured to, or operable to support a means for outputting a first set of SSBs or a first set of CSI-RSs, where the set of layer 3 beam measurements correspond to measurements of a second set of SSBs or a second set of CSI-RSs.

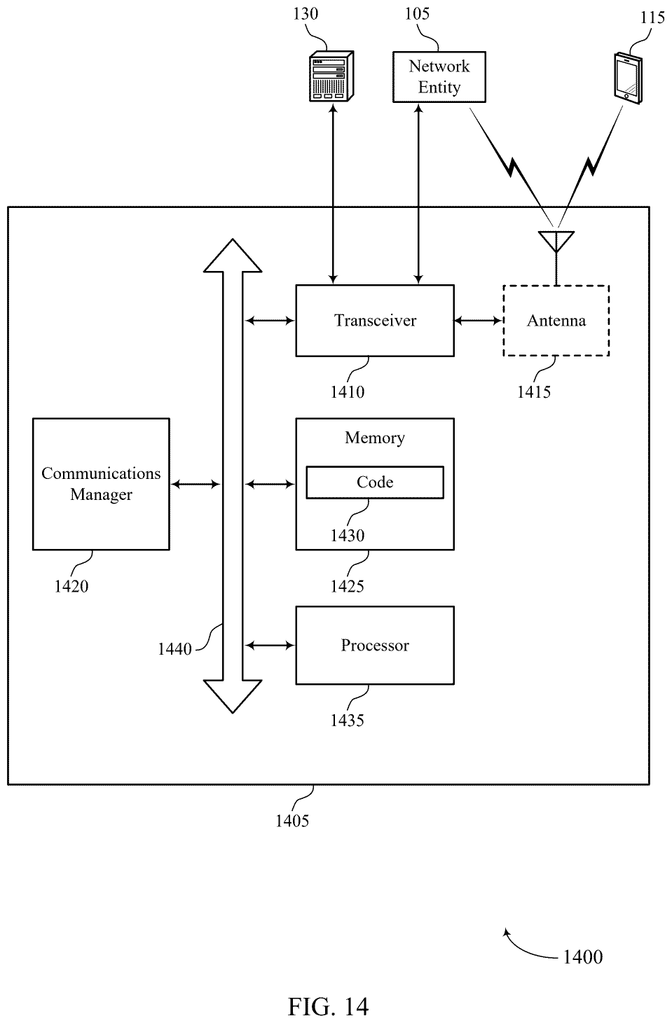

FIG. 14 shows a diagram of a system 1400 including a device 1405 that supports layer-3 beam and cell measurement predictions in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting layer-3 beam and cell measurement predictions). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting a set of reference signals. The communications manager 1420 is capable of, configured to, or operable to support a means for obtaining a report message indicating a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements.

By including or configuring the communications manager 1420 in accordance with examples as described herein, the device 1405 may support techniques for more efficient utilization of communication resources, improved coordination between devices, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of layer-3 beam and cell measurement predictions as described herein, or the at least one processor 1435 and the at least one memory 1425 may be otherwise configured to, individually or collectively, perform or support such operations.

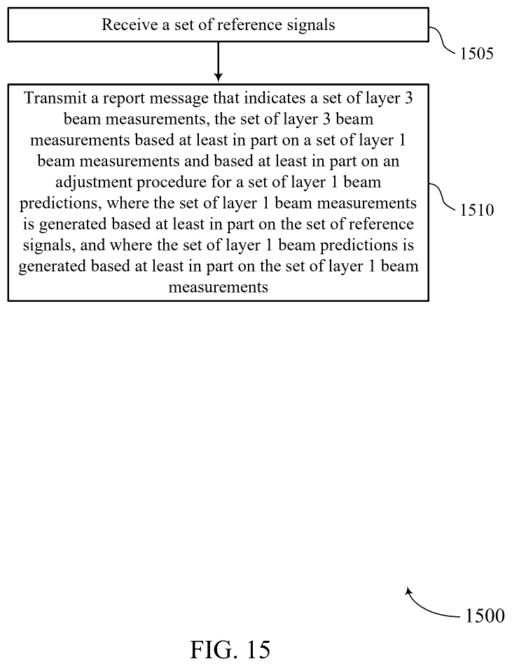

FIG. 15 shows a flowchart illustrating a method 1500 that supports layer-3 beam and cell measurement predictions in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a set of reference signals. The operations of 1505 may be performed in accordance with examples as disclosed herein. In some examples, aspects of the operations of 1505 may be performed by a reference signal reception manager 925 as described with reference to FIG. 9.

At 1510, the method may include transmitting a report message indicating a set of layer 3 beam measurements, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements. The operations of 1510 may be performed in accordance with examples as disclosed herein. In some examples, aspects of the operations of 1510 may be performed by a layer 3 beam measurement report manager 930 as described with reference to FIG. 9.

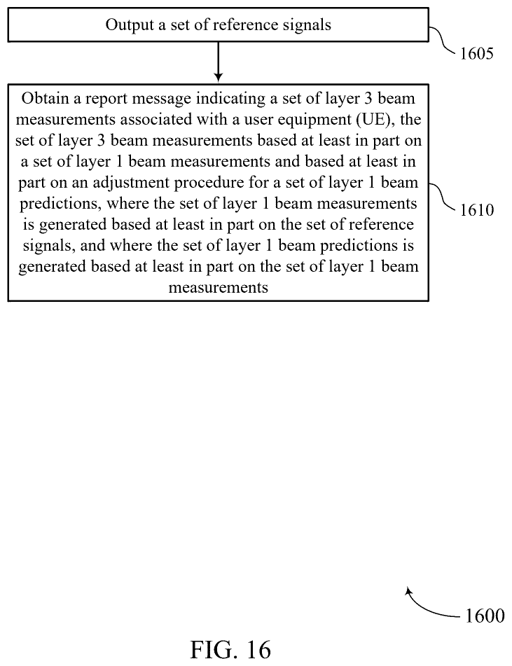

FIG. 16 shows a flowchart illustrating a method 1600 that supports layer-3 beam and cell measurement predictions in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include outputting a set of reference signals. The operations of 1605 may be performed in accordance with examples as disclosed herein. In some examples, aspects of the operations of 1605 may be performed by a reference signal transmission manager 1325 as described with reference to FIG. 13.

At 1610, the method may include obtaining a report message indicating a set of layer 3 beam measurements associated with a UE, the set of layer 3 beam measurements based on a set of layer 1 beam measurements and based on an adjustment procedure for a set of layer 1 beam predictions, where the set of layer 1 beam measurements is generated based on the set of reference signals, and where the set of layer 1 beam predictions is generated based on the set of layer 1 beam measurements. The operations of 1610 may be performed in accordance with examples as disclosed herein. In some examples, aspects of the operations of 1610 may be performed by a layer 3 beam measurement report manager 1330 as described with reference to FIG. 13.

The following provides an overview of aspects of the present disclosure:
Aspect 1: A method for wireless communications at a UE, comprising: receiving a set of reference signals; and transmitting a report message indicating a set of layer 3 beam measurements, the set of layer 3 beam measurements based at least in part on a set of layer 1 beam measurements and based at least in part on an adjustment procedure for a set of layer 1 beam predictions, wherein the set of layer 1 beam measurements is generated based at least in part on the set of reference signals, and wherein the set of layer 1 beam predictions is generated based at least in part on the set of layer 1 beam measurements.
Aspect 2: The method of aspect 1, further comprising: receiving, from a network entity, control information that indicates one or more adjustment parameters associated with layer 1 beam predictions, the adjustment procedure based at least in part on the one or more adjustment parameters.
Aspect 3: The method of aspect 2, wherein the one or more adjustment parameters include a first filtering coefficient value and an offset value.
Aspect 4: The method of aspect 3, further comprising: generating the set of layer 3 beam measurements based at least in part on multiplication of the set of layer 1 beam predictions by the first filtering coefficient value and addition of the offset value.
Aspect 5: The method of any of aspects 3 through 4, further comprising: receiving, via the control information, an indication of a second filtering coefficient value associated with layer 1 beam measurements, the second filtering coefficient value different from the first filtering coefficient value, wherein the set of layer 3 beam measurements is generated based at least in part on multiplication of the set of layer 1 beam measurements by the second filtering coefficient value.
Aspect 6: The method of any of aspects 2 through 5, wherein the one or more adjustment parameters include a set of filtering coefficient values associated with the layer 1 beam predictions and layer 1 beam measurements for layer 3 beam measurements, and the set of layer 3 beam measurements are generated based at least in part on a filtering coefficient value of the set of filtering coefficient values selected based on a quantity of layer 1 beam predictions of the set of layer 1 beam predictions.
Aspect 7: The method of any of aspects 2 through 6, wherein the control information indicates the one or more adjustment parameters for each carrier frequency of a set of carrier frequencies, for each radio access technology of a set of radio access technologies, or for each cell of a set of cells.
Aspect 8: The method of any of aspects 2 through 7, further comprising: transmitting, to the network entity, assistance information that indicates a recommended filtering coefficient value based at least in part on a set of prior layer 3 beam measurements generated by the UE, wherein reception of the control information is based at least in part on the assistance information.
Aspect 9: The method of any of aspects 1 through 8, wherein the transmitting the report message comprises: transmitting an indication of a confidence interval associated with the set of layer 3 beam measurements.
Aspect 10: The method of any of aspects 1 through 9, further comprising: modifying one or more layer 1 beam predictions of the set of layer 1 beam predictions based at least in part on subsequent layer 1 beam measurements corresponding to the one or more layer 1 beam predictions, wherein the subsequent layer 1 beam measurements are a subset of the set of layer 1 beam measurements, and wherein the adjustment procedure comprises the modifying the one or more layer 1 beam predictions.
Aspect 11: The method of aspect 10, further comprising: receiving, from a network entity, control information comprising an indication to modify the set of layer 1 beam predictions based at least in part on the subsequent layer 1 beam measurements, wherein the modifying the one or more layer 1 beam predictions of the set of layer 1 beam predictions is based at least in part on the control information.
Aspect 12: The method of aspect 11, wherein the control information further indicates a quantity of layer 1 beam predictions to modify.
Aspect 13: The method of any of aspects 1 through 12, further comprising: selecting, based at least in part on a distribution of the set of layer 1 beam measurements and the set of layer 1 beam predictions, a filtering coefficient value for application to layer 1 beam predictions and layer 1 beam measurements for generation of layer 3 beam measurements, a quantity of layer 3 beam measurements to include in the set of layer 3 beam measurements, or both.
Aspect 14: The method of aspect 13, further comprising: receiving, from a network entity, control information that indicates a range of candidate filtering coefficient values, a range of candidate quantities of layer 3 beam measurements, or both, wherein the selecting is based at least in part on the control information.
Aspect 15: The method of any of aspects 1 through 14, wherein the receiving the set of reference signals comprises: receiving a first set of SSBs or a first set of CSI-RSs, wherein the set of layer 3 beam measurements correspond to measurements of a second set of SSBs or a second set of CSI-RSs.
Aspect 16: A method for wireless communications at a network entity, comprising: outputting a set of reference signals; and obtaining a report message that indicates a set of layer 3 beam measurements associated with a UE, the set of layer 3 beam measurements based at least in part on a set of layer 1 beam measurements and based at least in part on an adjustment procedure for a set of layer 1 beam predictions, wherein the set of layer 1 beam measurements is generated based at least in part on the set of reference signals, and wherein the set of layer 1 beam predictions is generated based at least in part on the set of layer 1 beam measurements.
Aspect 17: The method of aspect 16, further comprising: outputting, to the UE, control information that indicates one or more adjustment parameters associated with layer 1 beam predictions, the adjustment procedure based at least in part on the one or more adjustment parameters.
Aspect 18: The method of aspect 17, wherein the one or more adjustment parameters include a first filtering coefficient value and an offset value.
Aspect 19: The method of aspect 18, wherein the set of layer 3 beam measurements are generated based at least in part on multiplication of the set of layer 1 beam predictions by the first filtering coefficient value and addition of the offset value.
Aspect 20: The method of any of aspects 18 through 19, further comprising: outputting, via the control information, an indication of a second filtering coefficient value associated with layer 1 beam measurements, the second filtering coefficient value different from the first filtering coefficient value, wherein the set of layer 3 beam measurements is generated based at least in part on multiplication of the set of layer 1 beam measurements by the second filtering coefficient value.
Aspect 21: The method of any of aspects 17 through 20, wherein the one or more adjustment parameters include a set of filtering coefficient values associated with the layer 1 beam predictions and layer 1 beam measurements for layer 3 beam measurements, and the set of layer 3 beam measurements are generated based at least in part on a filtering coefficient value of the set of filtering coefficient values selected based on a quantity of layer 1 beam predictions of the set of layer 1 beam predictions.
Aspect 22: The method of any of aspects 17 through 21, wherein the control information indicates the one or more adjustment parameters for each carrier frequency of a set of carrier frequencies, for each radio access technology of a set of radio access technologies, or for each cell of a set of cells.
Aspect 23: The method of any of aspects 17 through 22, further comprising: obtaining assistance information that indicates a recommended filtering coefficient value from the UE based at least in part on a set of prior layer 3 beam measurements associated with the UE, wherein transmission of the control information is based at least in part on the assistance information.
Aspect 24: The method of any of aspects 16 through 23, wherein the obtaining the report message comprises: obtaining an indication of a confidence interval associated with the set of layer 3 beam measurements.
Aspect 25: The method of any of aspects 16 through 24, further comprising: outputting control information comprising an indication to modify the set of layer 1 beam predictions based at least in part on subsequent layer 1 beam measurements, wherein the adjustment procedure is based at least in part on the control information.
Aspect 26: The method of aspect 25, wherein the control information further indicates a quantity of layer 1 beam predictions to modify.
Aspect 27: The method of any of aspects 16 through 26, further comprising: outputting control information that indicates a range of candidate filtering coefficient values, a range of candidate quantities of layer 3 beam measurements, or both, wherein the adjustment procedure is based at least in part on the control information.
Aspect 28: The method of any of aspects 16 through 27, wherein the outputting the set of reference signals comprises: outputting a first set of SSBs or a first set of CSI-RSs, wherein the set of layer 3 beam measurements correspond to measurements of a second set of SSBs or a second set of CSI-RSs.
Aspect 29: An apparatus for wireless communications at a UE, comprising one or more memories, and one or more processors coupled with the one or more memories and configured to cause the UE to perform a method of any of aspects 1 through 15.
Aspect 30: A UE for wireless communications, comprising at least one means for performing a method of any of aspects 1 through 15.
Aspect 31: A non-transitory computer-readable medium storing code for wireless communications at a UE, the code comprising instructions executable by one or more processors to cause a UE to perform a method of any of aspects 1 through 15.
Aspect 32: An apparatus for wireless communications at a network entity, comprising one or more memories, and one or more processors coupled with the one or more memories and configured to cause the network entity to perform a method of any of aspects 16 through 28.
Aspect 33: A network entity for wireless communications, comprising at least one means for performing a method of any of aspects 16 through 28.
Aspect 34: A non-transitory computer-readable medium storing code for wireless communications at a network entity, the code comprising instructions executable by one or more processors to cause a network entity to perform a method of any of aspects 16 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

As used herein, the phrase “a set” shall be construed as including the possibility of a set with one member. That is, the phrase “a set” shall be construed in the same manner as “one or more” or “at least one of.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive a set of reference signals; and
transmit a report message that indicates a set of layer 3 beam measurements, the set of layer 3 beam measurements based at least in part on a set of layer 1 beam measurements and based at least in part on an adjustment procedure for a set of layer 1 beam predictions, wherein the set of layer 1 beam measurements is generated based at least in part on the set of reference signals, and wherein the set of layer 1 beam predictions is generated based at least in part on the set of layer 1 beam measurements.

2. The apparatus of claim 1, wherein the one or more processors are configured to cause the UE to:
receive, from a network entity, control information that indicates one or more adjustment parameters associated with layer 1 beam predictions, the adjustment procedure based at least in part on the one or more adjustment parameters.

3. The apparatus of claim 2, wherein the one or more adjustment parameters include a first filtering coefficient value and an offset value.

4. The apparatus of claim 3, wherein the one or more processors are configured to cause the UE to:
generate the set of layer 3 beam measurements or predictions based at least in part on multiplication of the set of layer 1 beam predictions by the first filtering coefficient value and addition of the offset value.

5. The apparatus of claim 3, wherein the one or more processors are configured to cause the UE to:
receive, via the control information, an indication of a second filtering coefficient value associated with layer 1 beam measurements, the second filtering coefficient value different from the first filtering coefficient value, wherein the set of layer 3 beam measurements or predictions is generated based at least in part on multiplication of the set of layer 1 beam measurements by the second filtering coefficient value.

6. The apparatus of claim 2, wherein:
the one or more adjustment parameters include a set of filtering coefficient values associated with the layer 1 beam predictions and layer 1 beam measurements for layer 3 beam measurements, and
the set of layer 3 beam measurements are generated based at least in part on a filtering coefficient value of the set of filtering coefficient values selected based on a quantity of layer 1 beam predictions of the set of layer 1 beam predictions.

7. The apparatus of claim 2, wherein the one or more processors are configured to cause the UE to:
transmit, to the network entity, assistance information that indicates a recommended filtering coefficient value based at least in part on a set of prior layer 3 beam measurements generated by the UE, wherein reception of the control information is based at least in part on the assistance information.

8. The apparatus of claim 1, wherein, to transmit the report message, the one or more processors are configured to cause the UE to:
transmit an indication of a confidence interval associated with the set of layer 3 beam measurements.

9. The apparatus of claim 1, wherein the one or more processors are configured to cause the UE to:
modify one or more layer 1 beam predictions of the set of layer 1 beam predictions based at least in part on subsequent layer 1 beam measurements that correspond to the one or more layer 1 beam predictions, wherein the subsequent layer 1 beam measurements are a subset of the set of layer 1 beam measurements, and wherein the adjustment procedure comprises modification of the one or more layer 1 beam predictions.

10. The apparatus of claim 9, wherein the one or more processors are configured to cause the UE to:
receive, from a network entity, control information that includes an indication to modify the set of layer 1 beam predictions based at least in part on the subsequent layer 1 beam measurements, wherein the modification of the one or more layer 1 beam predictions of the set of layer 1 beam predictions is based at least in part on the control information.

11. The apparatus of claim 1, wherein the one or more processors are configured to cause the UE to:
receive, from a network entity, control information that indicates a range of candidate filtering coefficient values, a range of candidate quantities of layer 3 beam measurements, or both; and
select, based at least in part on a distribution of the set of layer 1 beam measurements and the set of layer 1 beam predictions, a filtering coefficient value for application to layer 1 beam predictions and layer 1 beam measurements for generation of layer 3 beam measurements, a quantity of layer 3 beam measurements to include in the set of layer 3 beam measurements, or both, wherein the selection is based at least in part on the control information.

12. An apparatus for wireless communication at a network entity, comprising:
one or more memories; and
one or more processors coupled with the one or more memories and configured to cause the network entity to:
output a set of reference signals; and
obtain a report message that indicates a set of layer 3 beam measurements associated with a user equipment (UE), the set of layer 3 beam measurements based at least in part on a set of layer 1 beam measurements and based at least in part on an adjustment procedure for a set of layer 1 beam predictions, wherein the set of layer 1 beam measurements is generated based at least in part on the set of reference signals, and wherein the set of layer 1 beam predictions is generated based at least in part on the set of layer 1 beam measurements.

13. The apparatus of claim 12, wherein the one or more processors are configured to cause the network entity to:
output control information that indicates one or more adjustment parameters associated with layer 1 beam predictions, the adjustment procedure based at least in part on the one or more adjustment parameters.

14. The apparatus of claim 13, wherein the one or more adjustment parameters include a first filtering coefficient value and an offset value.

15. The apparatus of claim 14, wherein the set of layer 3 beam measurements are generated based at least in part on multiplication of the set of layer 1 beam predictions by the first filtering coefficient value and addition of the offset value.

16. The apparatus of claim 14, wherein the one or more processors are configured to cause the network entity to:
output, via the control information, an indication of a second filtering coefficient value associated with layer 1 beam measurements, the second filtering coefficient value different from the first filtering coefficient value, wherein the set of layer 3 beam measurements is generated based at least in part on multiplication of the set of layer 1 beam measurements by the second filtering coefficient value.

17. The apparatus of claim 13, wherein:
the one or more adjustment parameters include a set of filtering coefficient values associated with the layer 1 beam predictions and layer 1 beam measurements for layer 3 beam measurements, and
the set of layer 3 beam measurements are generated based at least in part on a filtering coefficient value of the set of filtering coefficient values selected based on a quantity of layer 1 beam predictions of the set of layer 1 beam predictions.

18. The apparatus of claim 13, wherein the one or more processors are configured to cause the network entity to:
obtain assistance information that indicates a recommended filtering coefficient value from the UE based at least in part on a set of prior layer 3 beam measurements associated with the UE, wherein transmission of the control information is based at least in part on the assistance information.

19. The apparatus of claim 12, wherein, to obtain the report message, the one or more processors are configured to cause the network entity to:
obtain an indication of a confidence interval associated with the set of layer 3 beam measurements.

20. A method for wireless communications at a user equipment (UE), comprising:
receiving a set of reference signals; and
transmitting a report message indicating a set of layer 3 beam measurements, the set of layer 3 beam measurements based at least in part on a set of layer 1 beam measurements and based at least in part on an adjustment procedure for a set of layer 1 beam predictions, wherein the set of layer 1 beam measurements is generated based at least in part on the set of reference signals, and wherein the set of layer 1 beam predictions is generated based at least in part on the set of layer 1 beam measurements.
